(19) United States
(12) Patent Application Publication
(10) Pub. No.: US 2015/0129813 A1
(43) Pub. Date: May 14, 2015

(54) IRRADIATION-ASSISTED PRODUCTION OF NANOSTRUCTURES

(71) Applicant: Innova Dynamics, Inc., San Francisco, CA (US)

(72) Inventors: Sheng Peng, San Mateo, CA (US); Gayatri Keskar, Daly City, CA (US)

(21) Appl. No.: 14/537,819

(22) Filed: Nov. 10, 2014

Related U.S. Application Data
(60) Provisional application No. 61/902,119, filed on Nov. 8, 2013.

(51) Int. Cl. H01B 13/00; H01B 1/02; B22F 9/24

(52) U.S. Cl. CPC H01B 13/003; B22F 9/24; H01B 1/02
USPC 252/514; 75/345

(57) ABSTRACT

Methods of producing nanowires and resulting nanowires are described. In one implementation, a method of producing nanowires includes irradiating (i) a metal-containing reagent; (ii) a templating agent; (iii) a reducing agent; and (iv) a seed-promoting agent (SPA) in a reaction medium and under a condition of an elevated pressure above atmospheric pressure to produce nanowires.

### CROSS REFERENCE TO RELATED APPLICATION

This application claims the benefit of U.S. Provisional Application No. 61/902,119, filed on Nov. 8, 2013, the disclosure of which is incorporated herein by reference in its entirety.

### FIELD OF THE INVENTION

This disclosure relates generally to nanostructures. More particularly, this disclosure relates to the production of nanostructures, such as nanowires.

### BACKGROUND

Nano-sized materials (or nanostructures) can differ markedly from their analogous bulk materials. In particular, physical, electrical, optical, chemical, and other properties of nanostructures can correlate with their morphology, including shape and size. As a result, efforts have been made to develop methods for producing nanostructures with controllable morphology, hence tailoring their properties. Unfortunately, existing methods can suffer from poor yields and difficulty in attaining desired nanostructure morphology. Nanowires of high aspect ratios and small diameters, such as about 500 or greater in aspect ratio and about 30 nm or below in diameter, are particularly difficult to attain consistently and at adequate yields.

Metal nanostructures with high aspect ratios, such as silver nanowires, are emerging as transformative materials for numerous technology arenas due to their tunable electrical, optical, and chemical properties. For example, large scale production of metal nanostructures with well-controlled morphology and chemical composition is of great significance to the development of transparent conductive electrodes (or TCEs) with desired electrical and optical characteristics. Silver nanowire-based TCEs should have low haze along with high light transmission and high electrical conductivity to achieve desired performance for commercial applications. However, the interdependence of electrical and optical characteristics of a TCE poses fundamental challenges to haze reduction without compromising its electrical conductivity. Particularly for the touch screen market, a low haze TCE with desired specifications (e.g., no greater than about 0.5% in haze and no greater than about 100 Ohms/square (or Ω/sq) in sheet resistance) dictates a need for a high-yield synthesis of thin and long silver nanowires. Thus, development of a streamlined, fast, and energy efficient method for controlled synthesis of thin and long silver nanowires is desired to meet demands for electronic, optical, and opto-electronic applications.

It is against this background that a need arose to develop the embodiments described herein.

### SUMMARY

One aspect of this disclosure relates to a method of producing nanowires. In some embodiments, the method includes irradiating (i) a metal-containing reagent; (ii) a templating agent; (iii) a reducing agent; and (iv) a seed-promoting agent (SPA) in a reaction medium and under a condition of an elevated pressure above atmospheric pressure to produce nanowires.

In other embodiments, the method includes: (1) combining (i) a solvent; (ii) a metal-containing reagent; (iii) a templating agent; and (iv) a seed-promoting agent (SPA) to produce a reaction mixture; and (2) energizing the reaction mixture under conditions of applying a first energizing mechanism, followed by applying a second energizing mechanism, where one of the first energizing mechanism and the second energizing mechanism includes irradiation, and another one of the first energizing mechanism and the second energizing mechanism includes non-radiative heating.

Another aspect of this disclosure relates to a nanowire composition. In some embodiments, the nanowire composition includes a liquid and a particulate material, where at least 65% by number of the particulate material corresponds to nanowires, an average length of the nanowires is at least 10 μm, and an average diameter of the nanowires is no greater than 20 nm.

Other aspects and embodiments of this disclosure are also contemplated. The foregoing summary and the following detailed description are not meant to restrict this disclosure to any particular embodiment but are merely meant to describe various embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1A shows a flowchart for the production of nanowires, such as metal nanowires, according to an embodiment of this disclosure.

FIG. 1B shows a flowchart for a reaction including a seeding phase and a growth phase, according to an embodiment of this disclosure.

FIG. 2A shows an implementation of a single-staged reaction for the production of silver nanowires, according to an embodiment of this disclosure.

FIG. 2B shows another implementation of a single-staged reaction for the production of silver nanowires, according to an embodiment of this disclosure.

FIG. 2C shows another implementation of a single-staged reaction for the production of silver nanowires, according to an embodiment of this disclosure.

FIG. 2D shows another implementation of a single-staged reaction for the production of silver nanowires, according to an embodiment of this disclosure.

FIG. 2E shows another implementation of a single-staged reaction for the production of silver alloy nanowires, according to an embodiment of this disclosure.

FIG. 2F shows yet another implementation of a single-staged reaction for the production of silver nanowires, according to an embodiment of this disclosure.

FIG. 2G shows an implementation of a multi-staged reaction for the production of silver nanowires, according to an embodiment of this disclosure.

FIG. 2H shows another implementation of a multi-staged reaction for the production of silver nanowires, according to an embodiment of this disclosure.

FIG. 2I shows another implementation of a multi-staged reaction for the production of silver nanowires, according to an embodiment of this disclosure.

FIG. 2J shows yet another implementation of a multi-staged reaction for the production of core-shell nanowires, according to an embodiment of this disclosure.

FIG. 3 shows a progression of color changes during a single-staged reaction for the production of silver nanowires according to Example 1.

FIG. 4 shows typical optical microscope (or OM) and transmission electron microscope (or TEM) images of resulting silver nanowires produced according to Example 1.

FIG. 5 shows typical OM and TEM images of resulting silver nanowires produced according to a single-staged reaction of Example 2.

FIG. 6 shows a progression of color changes of a reaction mixture during microwave irradiation according to Example 3.

FIG. 7 shows a flow chart of a two-staged reaction for the production of silver nanowires according to Example 3.

FIG. 8 shows typical OM and TEM images of resulting silver nanowires produced according to the two-staged reaction of Example 3.

FIG. 9 shows morphologies of resulting silver nanowires produced by varying a duration of a second stage in the two-staged reaction of Example 3.

FIG. 10 compares morphologies of resulting silver nanowires produced by: (left panel) a single-staged reaction with microwave irradiation at power level 2 (about 140 W) for about 33 min; (middle panel) a two-staged reaction with seeding at about 95° C., followed by microwave irradiation at power level 2 (about 140 W) for about 35 min; and (right panel) a two-staged reaction with seeding at about 75° C., followed by microwave irradiation at power level 2 (about 140 W) for about 35 min.

FIG. 11 shows typical OM and TEM images of resulting silver nanowires produced according to a two-staged reaction of Example 4.

FIG. 12 shows typical microscopy images at various magnifications of resulting silver nanowires produced according to Example 4.

FIG. 13 shows typical OM and scanning electron microscope (or SEM) images of resulting silver nanowires produced according to a multi-staged reaction of Example 5.

FIG. 14 compares morphologies of resulting silver nanowires produced by: (left panel) a two-staged reaction with microwave-assisted seeding at power level 5 (about 350 W) for about 2 min, followed by heating at about 150° C. using a heating mantle; (middle panel) a two-staged reaction with microwave-assisted seeding at power level 2 (about 140 W) for about 13 min, followed by heating at about 120° C. using a heating mantle; and (right panel) a two-staged reaction with microwave-assisted seeding at power level 1 (about 70 W) for about 30 min, followed by heating at about 95° C. using a heating mantle.

FIG. 15 shows typical OM and SEM images of resulting silver nanowires produced according to a two-staged reaction of Example 6.

FIG. 16 shows typical OM and SEM images of resulting silver nanowires produced according to a single-staged reaction in the presence of water of Example 7.

FIG. 17 shows a typical OM image of resulting silver nanowires produced according a single-staged reaction under positive pressure of Example 8.

FIG. 18 shows typical OM and TEM images of resulting silver nanowires produced according a single-staged reaction under positive pressure of Example 9.

FIG. 19 shows typical OM and TEM images of resulting silver nanowires produced according a single-staged reaction under positive pressure of Example 10.

FIG. 20 shows an example Thermogravimetric Analysis (or TGA) procedure to determine an amount of a surface-bound templating agent.

### DETAILED DESCRIPTION

### Definitions

The following definitions apply to some of the aspects described with regard to some embodiments of this disclosure. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects. Objects of a set can also be referred to as members of the set. Objects of a set can be the same or different. In some instances, objects of a set can share one or more common characteristics.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the terms “optional” and “optionally” mean that the subsequently described event or circumstance may or may not occur and that the description includes instances where the event or circumstance occurs and instances in which it does not.

As used herein, the term “nanometer range” or “nm range” refers to a range of dimensions from about 1 nanometer (or nm) to about 1 micrometer (or μm). The nm range includes the “lower nm range,” which refers to a range of dimensions from about 1 nm to about 10 nm, the “middle nm range,” which refers to a range of dimensions from about 10 nm to about 100 nm, and the “upper nm range,” which refers to a range of dimensions from about 100 nm to about 1 μm.

As used herein, the term “micrometer range” or “μm range” refers to a range of dimensions from about 1 μm to about 1 millimeter (or mm). The μm range includes the “lower μm range,” which refers to a range of dimensions from about 1 μm to about 10 μm, the “middle μm range,” which refers to a range of dimensions from about 10 μm to about 100 μm, and the “upper μm range,” which refers to a range of dimensions from about 100 μm to about 1 mm.

As used herein, the term “aspect ratio” refers to a ratio of a largest dimension or extent of an object and an average of remaining dimensions or extents of the object, where the remaining dimensions can be substantially orthogonal with respect to one another and with respect to the largest dimension. In some instances, remaining dimensions of an object can be substantially the same, and an average of the remaining dimensions can substantially correspond to either of the remaining dimensions. In some instances, a largest dimension or extent of an object can be aligned with, or can extend along, a major axis of the object, while remaining dimensions of the object can be aligned with, or can extend along, respective minor axes of the object, where the minor axes can be substantially orthogonal with respect to one another and with respect to the major axis. For example, an aspect ratio of a cylinder refers to a ratio of a length of the cylinder and a cross-sectional diameter of the cylinder. As another example, an aspect ratio of a spheroid refers to a ratio of a dimension along a major axis of the spheroid and a dimension along a minor axis of the spheroid.

As used herein, the term “nano-sized” object refers to an object that has at least one dimension in the nm range. A nano-sized object can have any of a wide variety of shapes, and can be formed of a wide variety of materials. Examples of nano-sized objects include nanowires, nanotubes, nanoplatelets, nanoparticles, and other nanostructures.

As used herein, the term “nanowire” refers to an elongated, nano-sized object that is substantially solid. Typically, a nanowire has a lateral dimension (e.g., a cross-sectional dimension in the form of a width, a diameter, or a width or diameter that represents an average across orthogonal directions) in the nm range, a longitudinal dimension (e.g., a length) in the μm range, and an aspect ratio that is about 3 or greater.

As used herein, the term “nanoplatelet” refers to a planar-like nano-sized object that is substantially solid.

As used herein, the term “nanotube” refers to an elongated, hollow, nano-sized object. Typically, a nanotube has a lateral dimension (e.g., a cross-sectional dimension in the form of a width, an outer diameter, or a width or outer diameter that represents an average across orthogonal directions) in the nm range, a longitudinal dimension (e.g., a length) in the μm range, and an aspect ratio that is about 3 or greater.

As used herein, the term “nanoparticle” refers to a nano-sized object. Typically, each dimension (e.g., a cross-sectional dimension in the form of a width, a diameter, or a width or diameter that represents an average across orthogonal directions) of a nanoparticle is in the nm range, and the nanoparticle has an aspect ratio that is less than about 3, such as about 1.

As used herein, the term “micron-sized” object refers to an object that has at least one dimension in the μm range. Typically, each dimension of a micron-sized object is in the μm range or beyond the μm range. A micron-sized object can have any of a wide variety of shapes, and can be formed of a wide variety of materials. Examples of micron-sized objects include microwires, microtubes, microparticles, and other microstructures.

As used herein, the term “microwire” refers to an elongated, micron-sized object that is substantially solid. Typically, a microwire has a lateral dimension (e.g., a cross-sectional dimension in the form of a width, a diameter, or a width or diameter that represents an average across orthogonal directions) in the μm range and an aspect ratio that is about 3 or greater.

As used herein, the term “microtube” refers to an elongated, hollow, micron-sized object. Typically, a microtube has a lateral dimension (e.g., a cross-sectional dimension in the form of a width, an outer diameter, or a width or outer diameter that represents an average across orthogonal directions) in the μm range and an aspect ratio that is about 3 or greater.

As used herein, the term “microparticle” refers to a micron-sized object. Typically, each dimension (e.g., a cross-sectional dimension in the form of a width, a diameter, or a width or diameter that represents an average across orthogonal directions) of a microparticle is in the μm range, and the microparticle has an aspect ratio that is less than about 3, such as about 1.

As used herein, the term “seed” refers to a microparticle, a micron-sized cluster, a nanoparticle, a nano-sized cluster, or other micron-sized or nano-sized object, which can, or has the potential to, subsequently grow or be grown into a different sized or shaped object, such as a nanowire, a nanotube, a nanoplatelet, a larger nanoparticle, or another nanostructure or microstructure. In some example cases, a seed can be grown in an initial phase of a reaction, followed by a subsequent phase. In other example cases, a seed can be grown in a stand-alone reaction. In other example cases, nanowires can be grown in a stand-alone reaction that starts with nanowire-forming seeds as well.

As used herein, the term “non-nanowire-forming seeds” refers to seeds having particular structures, compositions, or chemical properties that exhibit limited, little, or no growth to form nanowires, such as in a later phase of a reaction or a stand-alone reaction, and can instead preferentially form other types of nanostructures, such as nanoplatelets or larger nanoparticles.

As used herein, the term “nanowire-forming seeds” refers to seeds having particular structures, compositions, or chemical properties, which can, or has the potential to, exhibit growth, such as via one-dimensional or axial growth, to form nanowires in a later phase of a reaction or a stand-alone reaction, and can, or has the potential to, preferentially form nanowires instead of other types of nanostructures. Examples of nanowire-forming seeds include multiple twinned nanoparticles, such as decahedron, five-fold twinned, or pentagonal nanoparticles.

As used herein, the term “single crystalline” or “monocrystalline” refers to an object in which a crystal lattice extends across the object to its boundaries, with a uniform crystalline orientation that is substantially devoid of crystalline orientation mismatches or grain boundaries. As will be understood, the presence of crystalline orientation mismatches or grain boundaries is a characteristic of a polycrystalline object. In the case of a population of objects, the population of objects can be characterized as single crystalline if a concentration of crystalline orientation mismatches or grain boundaries within the population of objects is no greater than about 1 per 10 objects, no greater than about 1 per 20 objects, no greater than about 1 per 50 objects, no greater than about 1 per 100 objects, no greater than about 1 per 200 objects, no greater than about 1 per 500 objects, or no greater than about 1 per 1,000 objects.

As used herein, the term “reagent” refers to a material that reacts in a chemical reaction, that is capable of influencing an extent or a rate of the reaction, or that is capable of influencing an abundance or characteristics of products formed in the reaction. A reagent can be a solid, a semi-solid, a liquid, a gas, a compound, a solution, or any combination thereof. A reagent also can be referred as a reactant.

As used herein, the term “binding” refers to an object forming a complex, coordinating, adhering, partially or otherwise covering, undergoing adsorption (e.g., physisorption, chemisorption, or both), undergoing absorption, interacting, or otherwise associating with another object.

As used herein, the term “energizing” refers to supplying energy to an object, where at least a portion of the supplied energy is absorbed by at least some component of the object.

As used herein, the term “heating” refers to energizing an object in a manner that transfers thermal energy to the object. Heating can be accomplished by, for example, irradiating an object or via non-radiative heating. The transfer of thermal energy can result in a change in temperature of an object.

As used herein, the term “irradiating” refers to energizing an object by supplying electromagnetic radiation to the object, where at least a portion of the supplied electromagnetic radiation is absorbed by at least some component of the object. The energy absorbed can result in a change in temperature of an object. Alternatively, or in conjunction, the energy can be absorbed in a manner that does not necessarily result in a change in temperature, such as by driving a chemical change, a change of physical state, or other reaction in an irradiated object. Electromagnetic radiation includes, for example, radiofrequency radiation, microwave radiation, terahertz radiation, infrared radiation, visible radiation, ultraviolet radiation, X-rays, gamma rays, or any combination thereof.

As used herein, the term “radiative” heating refers to heating an object by irradiation.

As used herein, the term “non-radiative” heating refers to heating an object in a manner other than by irradiation.

As used herein, the term “infrared radiation” refers to electromagnetic radiation characterized by a vacuum wavelength between about 700 nm and about 1 mm, or a frequency between about 430 terahertz (or THz) and about 300 GHz.

As used herein, the term “microwave radiation” refers to electromagnetic radiation characterized by a vacuum wavelength between about 1 mm and about 1 meter (m), or a frequency between about 300 gigahertz (or GHz) and about 0.3 GHz.

As used herein, the term “ultraviolet radiation” refers to electromagnetic radiation characterized by a vacuum wavelength shorter than that of the visible radiation, but longer than that of soft X-rays, namely between about 10 nm and about 400 nm, or a frequency between about 30 petahertz (or PHz) and about 750 THz. Ultraviolet radiation can be subdivided into the following wavelength ranges: near UV, from about 400 nm to about 200 nm; far or vacuum UV (FUV or VUV), from about 200 nm to about 10 nm; and extreme UV (EUV or XUV), from about 121 nm to about 10 nm.

As used herein, the term “visible radiation” refers to electromagnetic radiation that can be detected and perceived by the human eye. Visible radiation generally has a vacuum wavelength in a range from about 400 nm to about 700 nm, or a frequency between about 750 THz and about 430 THz.

As used herein, the term “vacuum wavelength” refers to a wavelength that electromagnetic radiation of a given frequency would have if the radiation is propagating through a vacuum, and is given by the speed of light in vacuum divided by the frequency of the electromagnetic radiation.

Additionally, concentrations, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

### Production of Nanowires

Embodiments described herein relate to the production of nanostructures with controllable morphologies. Examples of nanostructures include nanowires, which can be formed of a variety of materials, including metals (e.g., silver (or Ag), nickel (or Ni), palladium (or Pd), platinum (or Pt), copper (or Cu), and gold (or Au)), metal alloys, semiconductors (e.g., silicon (or Si), indium phosphide (or InP), and gallium nitride (or GaN)), metalloids (e.g., tellurium (or Te)), conducting oxides and chalcogenides that are optionally doped and transparent (e.g., metal oxides and chalcogenides that are optionally doped and transparent such as zinc oxide (or ZnO)), electrically conductive polymers (e.g., poly(aniline), poly(acetylene), poly(pyrrole), poly(thiophene), poly(p-phenylene sulfide), poly(p-phenylene vinylene), poly(3-alkylthiophene), olyindole, poly(pyrene), poly(carbazole), poly(azulene), poly(azepine), poly(fluorene), poly(naphthalene), melanins, poly(3,4-ethylenedioxy thiophene) (or PEDOT), poly(styrenesulfonate) (or PSS), PEDOT-PSS, PEDOT-poly(methacrylic acid), poly(3-hexylthiophene), poly(3-octylthiophene), poly(C-61-butyric acid-methyl ester), and poly[2-methoxy-5-(2′-ethyl-hexyloxy)-1,4-phenylene vinylene]), insulators (e.g., silica (or SiO₂) and titania (or TiO₂)), and any combination thereof. Nanowires can have a core-shell configuration or a core-multi-shell configuration.

In some embodiments, nanowire morphologies are controlled by incorporating a single-staged or multi-staged reaction along with purification of a resulting nanowire product. In such manner, desired nanowire morphologies can be achieved in high yields. In some embodiments, an irradiation-assisted, solution synthesis reaction is carried out for rapid, high-yield synthesis of nanowires with desired diameters and lengths for electronic, optical, and opto-electronic applications. Although certain embodiments are described in the context of nanowires, additional embodiments can be implemented for the production of other types of nanostructures with controllable morphologies, such as other types of nanostructures that are generally elongated and having an aspect ratio of about 3 or greater. Further embodiments can be implemented for the production of micron-sized structures (or microstructures) with controllable morphologies, such as microstructures that are generally elongated and having an aspect ratio of about 3 or greater.

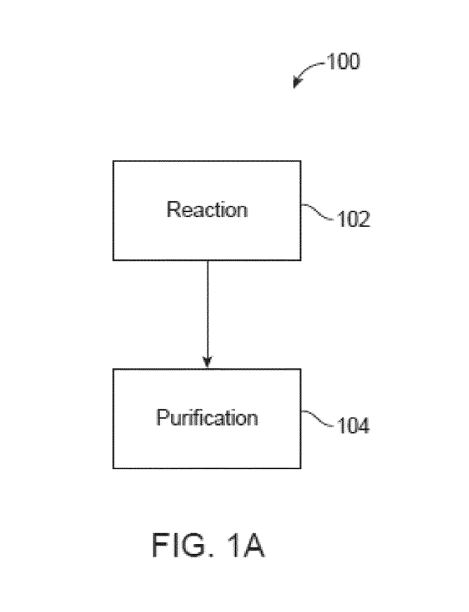

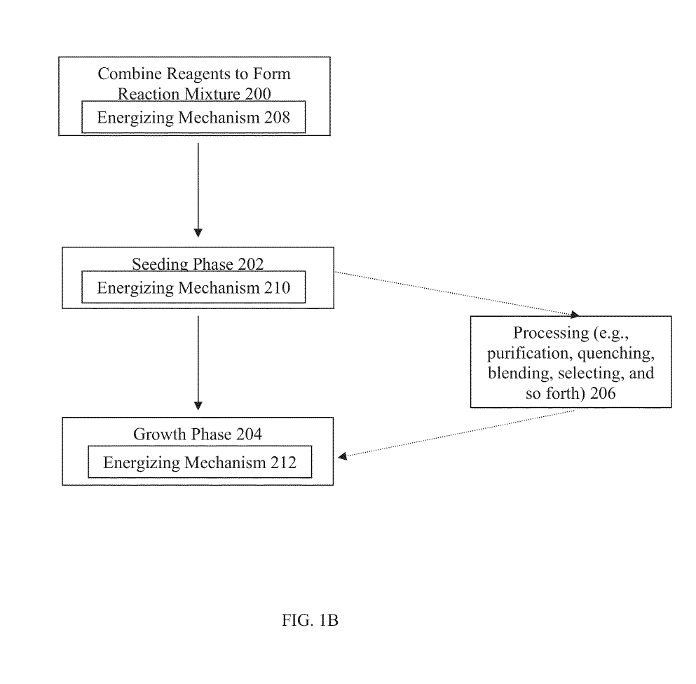

By way of overview, FIG. 1A shows a flowchart 100 for the production of nanowires, such as metal nanowires, according to an embodiment of this disclosure. The flowchart 100 includes a reaction phase 102 and a purification phase 104, which follows the reaction phase 102.

Referring to FIG. 1A, the reaction phase 102 is implemented to perform a solution synthesis reaction for the production of nanowires. In a solution synthesis reaction, nanowires can be grown from a reaction mixture including a set of solvents, a set of reagents including a material forming the nanowires, and a set of templating agents, where the set of solvents function as a reaction medium. As the reaction mixture is heated, a small amount of a metal-containing reagent transforms to form seeds, which can include non-nanowire-forming seeds and nanowire-forming seeds. For example, the templating agent may selectively or preferentially bind to a set of crystal faces of a nanowire-forming seed, thereby impeding or inhibiting growth on that set of crystal faces to which the templating agent is bound; further, because the templating agent has selectively or preferentially bound to a set of crystal faces, remaining crystal faces that have less templating agent bound to their surfaces will have preferentially higher growth. As another example, the templating agent may selectively or preferentially bind to a lateral crystal face of a nanowire-forming seed, thereby impeding growth in a radial direction, and selectively or preferentially allowing growth or lengthening in a longitudinal direction on crystal faces that are substantially perpendicular to the lateral crystal face. In the meanwhile, crystal faces of non-nanowire-forming seeds may be bound by the templating agent without or with little selectivity, and the seeds will not grow into nanowires. In an example of a solution synthesis reaction for the production of metal (e.g., silver) nanowires, a templating agent (e.g., poly(vinylpyrrolidone)) can selectively bind to the {1 0 0} face of a five-fold twinned seed, allowing growth on the {1 1 1} face in the [1 1 0] longitudinal direction. Other types of solution synthesis reactions are contemplated. More generally, the reaction phase 102 can be carried out in any suitable reaction medium for the production of nanowires, where the reaction medium can be a solid medium, a semi-solid medium, a fluid medium (e.g., a gas, a supercritical fluid, a solvent, a solvent mixture, a solution, or another liquid), or any combination thereof.

In the case of metal nanowires, examples of suitable metal-containing reagents include metal salts, such as silver nitrate (or AgNO₃), silver nitrite (or AgNO₂), silver acetate (or (CH₃COO)₂Ag), trifluorosilver acetate (or (CF₃COO)₂Ag), silver chlorate (or AgClO₃), silver perchlorate (or AgClO₄), silver fluoride (AgF), silver chloride (AgCl), silver trifluoromethanesulfonate (or AgSO₃CF₃), silver carbonate (or Ag₂CO₃), silver sulfate (or Ag₂SO₄), silver phosphate (or Ag₃PO₄), silver oxalate (or Ag₂C₂O₄), silver neodecanoate (or AgOOCC₉H₁₉), silver 2-ethylhexanoate (or AgOOCCH(C₂H₅)C₄H₉), silver ammoniacal compounds (or Ag(NH₃)₂⁺), silver permanganate (AgMnO₄), gold perchlorate (or Au(ClO₄)₃), chloroauric acid (or HAuCl₄), palladium (II) chloride (or PdCl₂), palladium acetylacetonate (or Pd(C₅H₇O₂)₂), palladium nitrate (or Pd(NO₃)₂), potassium tetrachloropalladate(II) (or K₂PdCl₄), platinum (II) chloride (or PtCl₂), potassium hexachloroplatinate (or K₂PtCl₆), chloroplatinic acid (or H₂PtCl₆), platinum acetylacetonate (or Pt(C₅H₂O₂)₂), and any combination thereof. It has been previously contemplated that the use of a silver-containing reagent different from AgNO₃ would not yield nanowires, but would rather yield nanoparticles instead of nanowires. In some embodiments of this disclosure, AgClO₄, among other silver-containing reagents different from AgNO₃ and with a solubility of at least or more than about 0.01 molar or at least or more than about 0.1 molar in a solvent, can be used in place of, or in combination with, AgNO₃ to attain silver nanowires with desired morphologies. Combinations of different silver-containing reagents can be used, such as where at least one of the silver-containing reagents is different from AgNO₃. For example, a first silver-containing reagent can be used in combination with a second silver-containing reagent that is different from the first silver-containing reagent and is different from AgNO₃, and a ratio (e.g., in terms of weight or moles) of an amount of silver introduced by the second silver-containing reagent and an amount of silver introduced by the first silver-containing reagent can be up to about 20:1, such as up to about 15:1, up to about 10:1, up to about 5:1, up to about 4.5:1, up to about 4:1, up to about 3.5:1, up to about 3:1, up to about 2.5:1, up to about 2:1, or up to about 1.5:1, and down to about 1:1, down to about 1:2, or less. In the case of silver-containing reagents different from AgNO₃, such as AgClO₄, it can be desirable to include a seed promoting agent that is a source of nitrate anions. Further details on seed promoting agents are explained below.

Additional examples of suitable metal-containing reagents include ionic liquids, such as silver-containing ionic liquids (e.g., a silver-containing cation as a center coordinated by one or more alkylamine ligands and a bis(trifluoromethylsulfonyl)imide (or Tf₂N) anion of the formula [Ag(L)₂][Tf₂N], where L is a monodentate amine such as tert-butylamine, iso-butylamine, sec-butylamine, 2-ethylhexylamine, di(2-ethylhexyl)amine, or piperidine, or of the formula [AgL′][Tf₂N], where L′ is a bidendate amine such as ethylenediamine; and bis(N-alkylethylenediamine)silver(I) nitrates (alkyl=hexyl, octly, dodecyl, or hexadecyl) as well as analogues thereof with PF₆ anion in place of nitrate anion), other metal-containing ionic liquids, and any combination thereof. Metal-containing ionic liquids can be used in place of, or in combination with, metal salts to attain metal nanowires with desired morphologies.

Further examples of suitable metal-containing reagents include organometallic compounds, such as organosilver compounds (e.g., arylsilver, complexes of silver with ylides, perfluoroalkylsilver, alkenylsilver, and silver-N-heterocyclic carbene complexes), organometallic compounds of metals other than silver, and any combination thereof. Organometallic compounds can be used in place of, or in combination with, metal salts and metal-containing ionic liquids to attain metal nanowires with desired morphologies.

Combinations of metal-containing reagents including different metals can be used. For example, a silver-containing reagent can be used in combination with at least one metal-containing reagent in which the metal is different from silver.

Examples of suitable templating agents (also sometimes referred as capping agents, surfactants, or protective agents) include molecules that each includes any one or more of a set of C atoms, a set of Si atoms, a set of O atoms, a set of N atoms, a set of Cl atoms, a set of P atoms, a set of Br atoms, and a set of S atoms, as well as inorganic, organic, and hybrid polymers, oligomers, or dimers formed of monomers that each includes any one or more of a set of C atoms, a set of Si atoms, a set of O atoms, a set of N atoms, a set of Cl atoms, a set of P atoms, a set of Br atoms, and a set of S atoms. Copolymers also can be suitable templating agents, including block-copolymers, alternating-copolymers, bipolymers, terpolymers, quaterpolymers (and so on), and graft macromolecules (e.g., a poly(vinylpyrrolidone) (or PVP) copolymer like poly(vinylpyrrolidone/vinylacetate) or a PVP copolymer with any other vinyl monomers). Molecules can include, for example, at least one functional group selected from a hydroxyl group (or —OH), a carboxylic group (or —COOH), an ester group (or —COOR), a thiol group (or —SH), a phosphine group (or —R₁R₂R₃P), a phosphine oxide group (or —R₁R₂R₃P═O), an amino group (or —NH₂), an ionic quaternary ammonium halide ion pair (e.g., R₁R₂R₃N⁺Cl⁻ or R₁R₂R₃N⁺Br⁻), where R, R₁, R₂, and R₃ are independently selected from hydrogen and organic groups (e.g., an aliphatic or aromatic, unsubstituted or substituted group including from 1 to 20 carbon atoms). Specific examples of suitable molecules as templating agents include oleylamine, octadecylamine, dodecylamine, dopamine, oleic acid, lauric acid, hexadecane thiol, mercaptopropionic acid, mercaptohexanol, trioctylphosphine, trioctylphosphine oxide, dioctadecyldimethylammonium chloride, cetyltrimethylammonium bromide, other molecules having a molecular weight (or MW) of about 1,000 or less or about 500 or less, and combinations thereof. Monomers and polymers formed from such monomers can include, for example, at least one functional group selected from a hydroxyl group, a carbonyl group (or —CO—), an ether linkage (or —O—, an amino group, and functional groups of the formulas: —COO—, —O—CO—O—, —CO—O—CO—, C—O—C, —CONR—, —NR—CO—O—, —NR₁—CO—NR₂—, —CO—NR—CO—, —SO₂NR— and —SO₂—O—, wherein R, R₁, and R₂ are independently selected from hydrogen and organic groups (e.g., an aliphatic or aromatic, unsubstituted or substituted group including from 1 to 20 carbon atoms). Specific examples of suitable templating agents include PVP, poly(arylamide), poly(acrylic), poly(vinyl acetate), poly(vinyl alcohol), and any combination or copolymer thereof. Molecules and monomers, such as those listed above, can be used in place of, or in combination with, polymers as templating agents. For example, N-vinylpyrrolidone (or another monomer having a molecular weight (or MW) of about 1,000 or less or about 500 or less) can be used in place of, or in combination with, PVP as a templating agent. An inorganic analog of PVP or other polymers, molecules, and monomers noted above (e.g., with Si in place of carbon) also can be used in place of, or in combination with, PVP as a templating agent.

In some embodiments, such as where at least a portion of the reaction phase 102 is carried out under a positive pressure (above atmospheric pressure), desired nanowire morphologies at high yields can be attained by using PVP (or another polymer) having a high number average or mass average MW, such as an average MW greater than about 55,000, greater than about 100,000, greater than about 200,000, greater than about 300,000, at least about 360,000, at least about 380,000, at least about 400,000, at least about 500,000, at least about 600,000, at least about 700,000, at least about 800,000, at least about 900,000, at least about 1,000,000, at least about 1,100,000, at least about 1,200,000, or at least about 1,300,000, and up to about 1,500,000 or more, up to about 1,700,000 or more, or up to about 1,900,000 or more. For example, PVP having an average MW of about 1,300,000 can be desirable for certain embodiments carried out under a positive pressure.

In some embodiments, desired nanowire morphologies at high yields can be attained by combining or blending two or more populations of PVP (or another polymer) having respective and different number average or mass average MWs, such as by blending a first population of PVP with a first average MW and a second population of PVP with a second average MW different from the first average MW, in an about 1:1 ratio (e.g., by weight or moles) or another ratio greater than or less than 1:1. For example, at least one of the first population of PVP and the second population of PVP can have a high average MW as specified above. The first average MW can be greater than, or less than, the second average MW by a difference of at least about 1,000, such as at least about 2,000, at least about 3,000, at least about 4,000, at least about 5,000, at least about 6,000, at least about 7,000, at least about 8,000, at least about 9,000, at least about 10,000, at least about 15,000, at least about 50,000, at least about 100,000, at least about 150,000, at least about 200,000, at least about 1,500,000, or more. In other embodiments, the difference in average MW can be up to about 1,500,000, up to about 200,000, up to about 100,000, up to about 50,000, or up to about 10,000.

Examples of suitable solvents include polar and non-polar solvents that function as a reaction medium in which a metal-containing reagent, a templating agent, and any other reagents or additives are sufficiently soluble. In addition, suitable solvents also can function (without the addition of exogenous reducing agents) under certain conditions to reduce at least a portion, or all, of the metal-containing reagent to its corresponding elemental metal form with zero valence. In some cases, for instance with a solvent like glycerol or another alcohol, the solvent can be oxidized to form a glycolaldehyde, which is capable of reducing metal ions (e.g., silver ions). Such a glycolaldehyde is an example of an endogenous reducing agent, namely one that is formed in-situ in a reaction mixture as part of, or during the course of, a reaction, rather than added to the reaction mixture as a reagent in the case of an exogenous reducing agent. More generally, an endogenous reducing agent can include an oxidized derivative or a partially or fully reacted form of a reaction medium or any other reagent or additive added to a reaction mixture, such as an aldehyde or other oxidized derivative of an alcohol like glycerol. In addition, suitable solvents also can function as an exogenous reducing agent itself. It is also contemplated that a separate, exogenous reducing agent can be used with a solvent, such as a hydride (e.g., sodium borohydride (or NaBH₄)), hydrazine, an amine, or trisodium citrate. The addition of the exogenous reducing agent can apply for cases where the solvent itself can function as an exogenous reducing agent, for cases where an endogenous reducing agent can be formed in-situ from the solvent, and for cases where the solvent has little or no endogenous and exogenous reducing capability.

In some embodiments, a suitable solvent includes, for example, at least one double bond per molecule, at least one primary or secondary amine group per molecule, at least one aldehyde group per molecule, at least two hydroxyl groups per molecule, or any combination thereof. Examples of suitable solvents include polar and non-polar primary amines (e.g., diethylamine), alcohols (e.g., polyols), and any combination thereof. More specifically, solvents including at least two hydroxyl groups per molecule, namely polyols, can be, for example, diols or glycols (e.g., ethylene glycol, diethylene glycol, triethylene glycol, polyethylene glycol, 1,2-propylene glycol, 1,4-butanediol, 1,2-butanediol, 1,3-propylene glycol, germinal diol, octane-1,8-diol, p-menthane-3,8-diol, and 1,5-pentanediol), glycerin, glycerol, glucose, or any combination thereof. In some embodiments, a solvent having a higher viscosity can mitigate against the formation of agglomerates. For example, compared to ethylene glycol (viscosity of about 16.9 centipoise (or cP) at room temperature), glycerol has a higher viscosity (about 1,410 cP at room temperature), and can be selected as a solvent. Other solvents having a higher viscosity than ethylene glycol can be similarly selected, such as having a viscosity of at least about 50 cP, at least about 100 cP, at least about 200 cP, at least about 300 cP, at least about 400 cP, at least about 500 cP, at least about 600 cP, at least about 700 cP, at least about 800 cP, at least about 900 cP, at least about 1,000 cP, at least about 1,100 cP, at least about 1,200 cP, at least about 1,300 cP, or at least about 1,400 cP, and up to about 2,000 or more at room temperature. In other embodiments, a solvent with a lower viscosity also can be used, particularly when the solvent is not an alcohol or when the alcohol is not ethylene glycol. Similarly, the viscosity of a reaction mixture can have an effect on the mitigation of agglomerate formation; for example, higher levels of templating agent can enhance the viscosity in the reaction mixture, such as in the case of a solvent of a lower viscosity like water. In some embodiments, a solvent having more than two hydroxyl groups per molecule can provide greater reducing strength or capability, which allows reactions to be carried out at lower temperatures to provide benefits in terms of attaining desired morphologies as well as ease and lower cost of manufacturing. For example, low temperature synthesis of nanowires with desired morphologies can be attained using glycerol as a solvent, among other polyols having at least three hydroxyl groups per molecule, at least four hydroxyl groups per molecule, or at least five hydroxyl groups per molecule, and up to ten hydroxyl groups per molecule or more. Similar benefits can be attained by using solvents including more than one primary or secondary amine group per molecule, or more than one aldehyde group per molecule.

Water also can be a suitable solvent. In some embodiments, water can be included along with one or more additional solvents, such as one or more polyols, to form a reaction medium, where a weight percent of water, relative to a total weight of the reaction medium, is in a range of up to about 90%, up to about 85%, up to about 80%, up to about 75%, up to about 70%, up to about 65%, up to about 60%, up to about 55%, up to about 50%, up to about 45%, up to about 40%, up to about 35%, up to about 30%, up to about 25%, up to about 20%, up to about 15%, up to about 10%, up to about 5%, or up to about 4%, and down to about 3%, down to about 2%, down to about 1%, or less. The inclusion of water can provide a number of benefits, including one or more of: (i) adjusting a viscosity of the reaction medium to promote greater efficiency of a reaction to produce nanowires; (ii) yielding an elevated pressure (and also an elevated reaction temperature) for a given irradiation power level, such as resulting from evaporation of water when the reaction is carried out in a sealed reactor; (iii) promoting the formation of longer nanowires, such as resulting from an elevated pressure; and (iv) a reduced cost of manufacturing and a greater eco-efficiency, such as by allowing a safer, greener, and more cost-effective synthesis of nanowires with little or no toxic by-products. In some embodiments, a high-yield synthesis of nanowires with desired diameters and lengths can be carried out in a reaction medium without requiring the addition of acids or acid compounds, thereby promoting a reduced cost of manufacturing and a greater eco-efficiency. For example, a pH of a reaction medium (or a resulting reaction mixture including other reagents) can be at least about 4.5, at least about 5, at least about 5.5, at least about 6, at least about 6.5, or at least about 6.7, and up to about 7.5, up to about 8, up to about 8.5, or more.

Additives can be included to increase yield and promote desired nanowire morphology as well as uniformity in desired nanowire morphology. Examples of suitable additives include seed promoting agents (or SPAs), which provide control over seeds in a reaction. SPAs can function according to any one or any combination of two or more of the following mechanisms: 1) SPAs can promote the formation of seeds having desired structures that will grow into desired nanostructures, such as nanowires, 2) SPAs can promote the formation of precursors or intermediates that will transform into or otherwise lead to seeds having desired structures, which, in turn, will grow into desired nanostructures, such as nanowires, 3) SPAs can promote an increase in a ratio (e.g., by number, weight, or moles) of seeds having desired structures over seeds having other structures, such as nanowire-forming seeds versus non-nanowire-forming seeds, and 4) SPAs can catalyze or otherwise expedite a reaction to grow seeds at a faster rate into nanostructures, including desired nanostructures.

Specific examples of SPAs that can promote the formation of nanowire-forming seeds or intermediates of nanowire-forming seeds include sources of halide anions, including halide salts such as alkali metal halides (e.g., sodium chloride (or NaCl), potassium chloride (or KCl), sodium bromide (or NaBr), potassium bromide (or KBr), and other chlorides, bromides, iodides, and fluorides of alkali metals), transition metal halides (e.g., platinum chloride (or PtCl₂), palladium chloride (or PdCl₂), manganese chloride (or MnCl₂), and other chlorides, bromides, iodides, and fluorides of transition metals), quaternary ammonium halides (e.g., tetrabutylammonium chloride (or TBAC), dioctadecyldimethyl ammonium chloride (or DDAC), didodecyldimethylammonium bromide (or DDAB), cetyltrimethylammonium chloride (or CTAC), and cetyltrimethylammonium bromide (or CTAB)), and any combination thereof.

Specific examples of SPAs that can increase a ratio between nanowire-forming seeds versus non-nanowire-forming seeds include iron salts, such as iron nitrate, iron acetate, iron chloride, and iron acetylacetonate in either the +2 or +3 valence, and sources of nitrate or nitrite anions, including nitrate salts or nitrite salts such as alkali metal nitrates (e.g., sodium nitrate (or NaNO₃), potassium nitrate (or KNO₃), and other nitrates of alkali metals), ammonium nitrate (or NH₄NO₃), alkali metal nitrites (e.g., sodium nitrite (or NaNO₂), potassium nitrite (or KNO₂), and other nitrites of alkali metals), ammonium nitrite (or NH₄NO₂), and other sources of nitrate or nitrite anions (e.g., nitric acid (or HNO₃) and nitrous acid (or HNO₂)), as well as any combination thereof. A SPA that is a source of nitrate or nitrite anions also can be a source of a metal, such as silver.

Specific examples of SPAs that can catalyze or expedite growth of nanowire-forming seeds into nanowires include transition metal salts, such as copper salts (e.g., copper in either the +1 or +2 valence, such as copper (I) chloride (or CuCl), copper (II) chloride (or CuCl₂), copper (II) nitrate (or Cu(NO₃)₂), and copper (II) sulfate (or CuSO₄)), manganese salts (e.g., manganese chloride (or MnCl₂)), iron salts (e.g., iron chloride (or FeCl₃) and iron nitrate (or Fe(NO₃)₃)), zinc salts (e.g., zinc chloride (or ZnCl₂)), cobalt salts (e.g., cobalt chloride (or CoCl₂)), and nickel salts (e.g., nickel chloride (or NiCl₂)), salts of p-block metals, such as bismuth salts (e.g., bismuth nitrate (or Bi(NO₃)₃)), tin salts (e.g., tin chloride (or SnCl₂)), and aluminum salts (e.g., aluminum chloride (or AlCl₃)), alkali earth metal salts (e.g., magnesium chloride (or MgCl₂)), alkali metal salts (e.g., lithium chloride (or LiCl)), and other halides, nitrates, and sulfates of transition metals, alkali earth metals, alkali metals, and p-block metals, as well as any combination thereof.

Further examples of SPAs include microstructures and nanostructures, which include surfaces to which nanowire-forming seeds are bound. For example, SPAs can include microparticles or nanoparticles (e.g., AgCl microparticles or nanoparticles or AgBr microparticles or nanoparticles) including surfaces decorated with nanowire-forming seeds (e.g., 5-fold twinned or pentagonal nanowire-forming seeds). The microparticles or nanoparticles can be exogenously added, can be formed in-situ or endogenously from an exogenously added SPA or other reagent, or both.

Nanowires having long lengths and small diameters are desirable for certain applications, such as transparent conductors (or TCEs). The long lengths of the nanowires promote connectivity between adjacent nanowires and improved electrical conductance characteristics, such as reduced sheet resistance values. In conjunction, the small diameters of the nanowires promote improved optical characteristics, such as in terms of reduced haze values. To produce long nanowires having small diameters, the reaction phase 102 can be implemented as a single-staged reaction or a multi-staged reaction including at least two stages. Generally, to produce long nanowires, a reaction can initially form nanowire-forming seeds using a small amount of a metal-containing reagent, and then subsequently allow one-dimensional or axial growth of the nanowire-forming seeds by consuming a remaining, larger amount of the metal-containing reagent. For example, a single-staged reaction can be carried out by applying an energizing mechanism so that a reduced or minimal amount of the metal-containing reagent decomposes into nanowire-forming seeds, and then, by applying the same energizing mechanism, the nanowire-forming seeds can consume a remaining, larger amount of the metal-containing reagent to grow into long nanowires. In this example, the energizing mechanism can include microwave irradiation or other mechanism of irradiation, such as infrared, ultraviolet, or visible radiation. As another example, a multi-staged reaction can be carried out by applying a first energizing mechanism during a first stage of the reaction encompassing seed formation, followed by applying a second energizing mechanism during a second stage of the reaction encompassing nanowire growth, where the first energizing mechanism is different from the second energizing mechanism. In this example, the first energizing mechanism can include microwave or other mechanism of irradiation, while the second energizing mechanism can include non-radiative heating, or vice versa. In some implementations, a ratio (e.g., in terms of weight or moles and expressed as a percentage) of an amount of a metal nucleating into seeds (in elemental metal form and including either, or both, nanowire-forming seeds and non-nanowire-forming seeds) and a total amount of the metal introduced during all stages of the reaction phase 102 can be in a range up to about 90%, such as up to about 75%, up to about 50%, up to about 25%, up to about 20%, up to about 15%, up to about 10%, up to about 5%, up to about 2%, up to about 1.8%, up to about 1.5%, up to about 1%, up to about 0.5%, or up to about 0.1%, and down to about 0.03%, down to about 0.01%, down to about 0.001%, or less.

Microwave irradiation (or another mechanism of irradiation) can be effective in reaching a desired reaction temperature quickly to facilitate a reaction in a short time, thereby allowing accelerated growth of nanowires. Without wishing to be bound by a particular theory, it is proposed that radiative heating of a reaction medium, such as through microwave irradiation, can accelerate the growth of metal nanowires by kinetically favoring chemical processes with a rapid temperature rise, such as resulting from more efficient and uniform localized heating. In the case of metal nanowires, an oscillating microwave field also can polarize conducting electrons in the nanowires, causing dielectric superheating and charge localization at vertices. As a result, ends of the nanowires can serve as local hot spots and preferential sites for deposition of silver to promote axial growth of the nanowires. In addition to the benefits of accelerated growth, microwave irradiation (or another mechanism of irradiation) can enhance yields of nanowires, such as by accelerating and promoting the formation of nanowire-forming seeds (or intermediates of nanowire-forming seeds) versus non-nanowire-forming seeds. A power level and a duration of irradiation can be adjusted depending upon a volume of a reaction mixture to attain long and thin metal nanowires at high yields and in a highly consistent or reproducible manner.

In some embodiments, the reaction phase 102 of FIG. 1A can be carried out to produce metal nanowires by combining: (a) at least one solvent; (b) at least one metal-containing reagent; (c) at least one templating agent; and (d) at least one SPA to form a reaction mixture, and energizing, through microwave irradiation or other energizing mechanism, the reaction mixture under reaction conditions that are controlled or optimized to produce desirable nanowire morphologies at high yields.

In other embodiments, the reaction phase 102 of FIG. 1A can be carried out to produce metal nanowires by energizing, through microwave irradiation or other energizing mechanism: (a) at least one metal-containing reagent; (b) at least one templating agent; (c) at least one reducing agent; and (d) at least one SPA in a reaction medium and under reaction conditions that are controlled or optimized to produce desirable nanowire morphologies at high yields. The reducing agent can include a reducing agent that is formed in-situ (e.g., as an oxidized derivative of the reaction medium), a reducing agent that is exogenously added, or both.

In other embodiments, the reaction phase 102 of FIG. 1A can be carried out to produce metal nanowires by combining: (a) at least one solvent; (b) at least one metal-containing reagent; (c) at least one templating agent; and (d) at least one SPA to form a reaction mixture, energizing, through microwave irradiation or other energizing mechanism, the reaction mixture to produce nanowire-forming seeds, followed by continued energizing of the seeds and at least a portion of the reagents (a) through (d), through the same or a different energizing mechanism, to produce desirable nanowire morphologies at high yields.

In other embodiments, the reaction phase 102 of FIG. 1A can be carried out by energizing, through microwave irradiation or other energizing mechanism: (a) at least one metal-containing reagent; (b) at least one templating agent; (c) at least one reducing agent; and (d) at least one SPA in a reaction medium to produce nanowire-forming seeds, followed by continued energizing of the seeds and at least a portion of the reagents (a) through (d) in the reaction medium, through the same or a different energizing mechanism, to produce desirable nanowire morphologies at high yields. The reducing agent can include a reducing agent that is formed in-situ (e.g., as an oxidized derivative of the reaction medium), a reducing agent that is exogenously added, or both.

In some embodiments, the reaction phase 102 of FIG. 1A can be carried out as shown in FIG. 1B, and can include: (i) an initial phase 200, which is carried out by combining various reagents and energizing using an energizing mechanism 208 to form a reaction mixture; (ii) a seeding phase 202, which is carried out by energizing the reaction mixture using an energizing mechanism 210; and (iii) followed by a growth phase 204, which is carried out by energizing the reaction mixture using an energizing mechanism 212. In the case of a single-staged reaction, the initial phase 200, the seeding phase 202, and the growth phase 204 can be encompassed within the single-staged reaction. In some cases of a multi-staged reaction, the initial phase 200 and the seeding phase 202 can be encompassed within a portion of a first stage, and the growth phase 204 can be encompassed within a remaining portion of the first stage as well as a second stage (plus any one or more subsequent stages). In other cases of a multi-staged reaction, the initial phase 200 and the seeding phase 202 can be encompassed within a first stage, and the growth phase 204 can be encompassed within a second stage (plus any one or more subsequent stages).

At the initial phase 200 of FIG. 1B, various reagents are introduced, combined, and energized using the energizing mechanism 208 to form a reaction mixture. The reagents can be combined as solutions or in a solid or semi-solid form, such as a granular form, a paste, a slurry, a quasi-solid, a powdered form, or as a mixture of a reagent in a fluid that does not dissolve that reagent. As used herein, a solution can refer to a homogeneous or heterogeneous mixture including a set of solvents and a set of reagents dispersed or suspended in the set of solvents. A solution also can refer to a homogenous material, such as an ionic liquid or a mixture of an ionic liquid with another material or materials. In some instances, a reagent may not fully or substantially dissolve in a solvent such that a solution can be characterized as a dispersion or a suspension of the reagent in the solvent. Accordingly, as used herein, a solution can encompass a suspension as well as a mixture where a reagent is fully or substantially dissolved. In general, the order of introduction of reagents can be varied as the reagents can be combined in various ways. For example, a metal salt can be incorporated in a solution including the metal salt in a first portion of a solvent, and a templating agent can be incorporated in another solution including the templating agent in a second portion of the solvent. The metal salt solution and the templating agent solution, in some embodiments, can be simultaneously or sequentially added to a third portion of the solvent. This addition can be drop-wise or portion-wise. As another example, the metal salt solution and the templating agent solution can be combined together, and a resulting mixture can be added to the third portion of the solvent. As noted above, either, or both, of the metal salt and the templating agent can be combined in a solid or semi-solid form. For example, a metal salt can be incorporated in a solution including the metal salt in a solvent, and a templating agent can be added in a solid form to the metal salt solution. As another example, a templating agent can be incorporated in a solution including the templating agent in a solvent, and a metal salt can be added in a solid form to the templating agent solution. As a further example, a metal salt and a templating agent can be introduced into a reaction vessel or other reactor, both in a solid or a semi-solid form, and a solvent is subsequently introduced into the reaction vessel. Additives, such as SPAs, also be combined as solutions or in a solid or semi-solid form. Surprisingly, despite the perceived non-uniformities and inconsistencies that could result from the addition of heterogeneous forms of reagents to reaction mixtures, through the methods disclosed herein, adding certain reagents in a solid or semi-solid form has resulted in a high quality and a high level of consistency. Additionally, rather than adding reagents in a solid or semi-solid form to a liquid, in other embodiments, solid or semi-solid forms of reagents can be mixed to form a solid or semi-solid reagent mixture (e.g., of PVP powder and AgNO₃ powder); subsequently, a solvent can be added to the solid or semi-solid mixture. For example, in powder form, the PVP can be considered a mixture of PVP and a fluid, wherein the fluid is air.

Following the initial phase 200, the reaction phase 102 can be carried out by energizing, using the energizing mechanism 210 in the seeding phase 202: (a) at least one metal-containing reagent; (b) at least one templating agent; (c) at least one reducing agent; and (d) at least one SPA in a reaction medium to produce nanowire-forming seeds, followed by, using the energizing mechanism 212 in the growth phase 204, continued energizing of the seeds and at least a portion of the reagents (a) through (d) in the reaction medium to produce desirable nanowire morphologies at high yields. The reducing agent can include a reducing agent that is formed in-situ (e.g., as an oxidized derivative of the reaction medium), a reducing agent that is exogenously added, or both. It is contemplated that additional reagents can be added to the reaction medium in the growth phase 204, such as an additional amount of the same or a different metal-containing reagent in the case of a multi-staged reaction. It is also contemplated that an additional amount of the same or a different templating agent can be added to the reaction medium in the growth phase 204. It is also contemplated that an additional amount of the same or a different reducing agent can be formed in-situ or can be added to the reaction medium in the growth phase 204. It is also contemplated that an additional amount of the same or a different SPA can be added to the reaction medium in the growth phase 204.

In some embodiments, the seeding phase 202 and the growth phase 204 can be viewed as successive or interspersed portions of a single, substantially continuous reaction. In other embodiments, the seeding phase 202 and the growth phase 204 can be viewed as separate reactions, with the former reaction carried out for the production of nanowire-forming seeds, and the latter reaction carried out for the production of nanowires from the nanowire-forming seeds. In such embodiments, a reaction mixture in the seeding phase 202 optionally can be quenched or otherwise cooled to a desired temperature in a processing phase 206, such as about room temperature, and optionally can be subjected to purification or other processing in the phase 206 to yield a purified product including nanowire-forming seeds. The nanowire-forming seeds can be exogenously added to a reaction medium in the growth phase 204, in place of, or in combination with, in-situ formation of nanowire-forming seeds in the reaction medium. Aspects of quenching and purification can be carried out as further explained below in the context of nanowires.

For example, the seeding phase 202 can be carried out by energizing, using the energizing mechanism 210: (a) at least one metal-containing reagent; (b) at least one templating agent; (c) at least one reducing agent; and (d) at least one SPA in a reaction medium, thereby producing nanowire-forming seeds. The reducing agent can include a reducing agent that is formed in-situ (e.g., as an oxidized derivative of the reaction medium), a reducing agent that is exogenously added, or both.

As another example, the growth phase 204 can be carried out by energizing, using the energizing mechanism 212: (a) at least one metal-containing reagent; (b) at least one templating agent; (c) at least one reducing agent; (d) at least one nanowire-forming seed; and (e) optionally at least one SPA in a reaction medium, thereby producing nanowires. The reducing agent can include a reducing agent that is formed in-situ (e.g., as an oxidized derivative of the reaction medium), a reducing agent that is exogenously added, or both. The nanowire-forming seeds can include seeds that are formed in-situ, seeds that are exogenously added, or both.

In general, the energizing mechanisms 208, 210, and 212 applied during the initial phase 200, the seeding phase 202, and the growth phase 204 can be the same or different, and can be independently selected from various mechanisms of irradiation and non-radiative heating. For example, irradiation can be applied during the seeding phase 202, and non-radiative heating can be applied during the growth phase 204. Alternatively, non-radiative heating can be applied during the seeding phase 202, and irradiation can be applied during the growth phase 204. As a further example, irradiation can be applied during the seeding phase 202, and the same or a different mechanism of irradiation can be applied during the growth phase 204. In some embodiments, irradiation can be applied at least during the seeding phase 202 to promote higher yields of nanowires having long lengths. Also, multiple cycles of alternating irradiation and non-radiative heating can be applied during the seeding phase 202, during the growth phase 204, or during both the seeding phase 202 and the growth phase 204. In addition, concurrent irradiation and non-radiative heating can be applied during the seeding phase 202, during the growth phase 204, or during both the seeding phase 202 and the growth phase 204. In some embodiments, irradiation also can be applied during the initial phase 200 to promote higher yields of nanowires. It is also contemplated that multiple cycles of alternating irradiation and non-radiative heating or concurrent irradiation and non-radiative heating can be applied during the initial phase 200.

Irradiation can include supplying electromagnetic radiation to a reaction mixture. The electromagnetic radiation can include microwave radiation, infrared radiation, visible radiation, ultraviolet radiation, or a combination of two or more of the foregoing. For example, ultraviolet irradiation can be applied during the seeding phase 202, while microwave irradiation can be applied during the growth phase 204, or vice versa. Non-radiative heating can include convective heating, conductive heating, acoustic heating, or a combination of two or more of the foregoing. For example, non-radiative heating can include the use of a heating mantle or an autoclave, or sonication through the application of ultrasound.

Desirable nanowire morphologies can be attained by selecting or controlling any one or any combination of two or more of the following reaction conditions within a reaction parameter matrix:

(1) To promote the formation of long and thin nanowires at high yields, at least one, or any combination of two or more, of the initial phase 200, the seeding phase 202, and the growth phase 204 can be carried out under a moderately elevated pressure (above atmospheric pressure) in a range of greater than about 14.7 psi (or about 1 atm), such as at least about 15 psi (or about 1.02 atm), at least about 17 psi (or about 1.2 atm), or at least about 19 psi (or about 1.3 atm), and up to about 50 psi (or about 3.4 atm) or more, such as up to about 49 psi (or about 3.3 atm), up to about 48 psi (or about 3.26 atm), up to about 47 psi (or about 3.2 atm), up to about 46 psi (or about 3.13 atm), up to about 45 psi (or about 3.1 atm), up to about 40 psi (or about 2.7 atm), up to about 35 psi (or about 2.4 atm), up to about 30 psi (or about 2 atm), up to about 25 psi (or about 1.7 atm), or up to about 20 psi (or about 1.4 atm). An elevated pressure can be applied by energizing reagents in a sealed reactor, or through another pressurizing mechanism.

(2) To promote the formation of nanowires at high yields, microwave or another mechanism of irradiation can be applied during the initial phase 200 when combining various reagents to form the reaction mixture. For example, microwave irradiation can be applied at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 5 sec to about 10 min, about 10 sec to about 5 min, about 10 sec to about 4 min, about 10 sec to about 3 min, or about 10 sec to about 2 min. Another mechanism of irradiation, such as infrared, ultraviolet, or visible radiation, or non-radiative heating can be used in place of, or in combination with, microwave irradiation.

(3) In the case of a single-staged reaction, microwave or another mechanism of irradiation can be applied during both the seeding phase 202 and the growth phase 204 to accelerate the formation of long nanowires at high yields. For example, microwave irradiation can be applied at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 30 sec to about 8 hr, about 1 min to about 5 hr, about 1 min to about 4 hr, about 5 min to about 4 hr, about 10 min to about 4 hr, about 10 min to about 3 hr, about 10 min to about 2 hr, or about 10 min to about 1 hr. For a certain volume of the reaction mixture (or a certain volume of a reaction medium), a volumetric power density supplied to the reaction mixture through microwave irradiation, or other mechanism of irradiation, can be in a range of about 100 W/L to about 7,500 W/L, about 100 W/L to about 7,000 W/L, about 500 W/L to about 7,500 W/L, about 500 W/L to about 7,000 W/L, about 700 W/L to about 7,000 W/L, or about 700 W/L to about 3,500 W/L, and a volumetric energy density supplied to the reaction mixture through microwave irradiation, or other mechanism of irradiation, over the duration of the reaction can be in a range of about 1.5×10⁴ J/L to about 2.5×10⁸ J/L, about 5×10⁴ J/L to about 10⁸ J/L, about 10⁵ J/L to about 10⁸ J/L, about 5×10⁵ J/L to about 10⁸ J/L, about 10⁶ J/L to about 10⁸ J/L, about 10⁶ J/L to about 5×10⁷ J/L, or about 10⁶ J/L to about 10⁷ J/L. Another mechanism of irradiation, such as infrared, ultraviolet, or visible radiation, or non-radiative heating can be used in place of, or in combination with, microwave irradiation. In some embodiments, it can be desirable to apply a higher power level for a shorter duration of time, or a lower power level for a longer duration of time, depending on a total amount of microwave energy to be applied per unit volume of the reaction mixture. To apply a larger total amount of microwave energy per unit volume, it can be desirable to apply a lower power level for a longer duration of time to promote the formation of desirable nanowire morphologies.

A sequence of different irradiation power levels and their respective durations can be adjusted to control a seeding temperature during the seeding phase 202 and a growth temperature during the growth phase 204. In general, a seeding temperature and a growth temperature can be the same or different, although, for some embodiments, benefits in terms of desired nanowire morphologies at high yields can be attained by selecting a higher seeding temperature compared to a growth temperature. For example, the seeding temperature can be maintained for at least a portion of the seeding phase 202 (such as at least about 50%, at least about 60%, at least about 70%, at least about 80%, at least about 90%, or substantially throughout an entire duration of the seeding phase 202) in a range of at least about 100° C., at least about 105° C., at least about 110° C., at least about 115° C., at least about 120° C., at least about 125° C., at least about 130° C., at least about 135° C., at least about 140° C., at least about 145° C., at least about 150° C., at least about 155° C., at least about 160° C., or at least about 165° C., and up to about 170° C., up to about 180° C., up to about 190° C., up to about 200° C., or more, while the growth temperature can be maintained for at least a portion of the growth phase 204 (such as at least about 50%, at least about 60%, at least about 70%, at least about 80%, at least about 90%, or substantially throughout an entire duration of the growth phase 204) in a range of up to about 140° C., up to about 135° C., up to about 130° C., up to about 125° C., up to about 120° C., up to about 115° C., up to about 110° C., up to about 105° C., up to about 100° C., up to about 95° C., or up to about 90° C., and down to about 85° C., down to about 80° C., down to about 70° C., down to about 60° C., or less. As another example, the seeding temperature for at least a portion of the seeding phase 202 can be in a range of about 100° C. to about 200° C., about 110° C. to about 190° C., about 120° C. to about 180° C., about 120° C. to about 150° C., about 150° C. to about 170° C., or about 150° C. to about 180° C., while the growth temperature for at least a portion of the growth phase 204 can be lower with a temperature difference of at least or greater than about 5° C., at least about 10° C., at least about 15° C., at least about 20° C., at least about 25° C., or at least about 30° C., and up to about 40° C., up to about 50° C., or more, such as where the growth temperature is in a range of about 60° C. to about 140° C., about 70° C. to about 130° C., about 80° C. to about 120° C., about 80° C. to about 100° C., or about 100° C. to about 120° C. As another example, the seeding temperature, when averaged over a duration of the seeding phase 202, can be in a range of about 100° C. to about 200° C., about 110° C. to about 190° C., about 120° C. to about 180° C., about 120° C. to about 150° C., about 150° C. to about 170° C., or about 150° C. to about 180° C., while the growth temperature, when averaged over a duration of the growth phase 204, can be lower with a temperature difference of at least or greater than about 5° C., at least about 10° C., at least about 15° C., at least about 20° C., at least about 25° C., or at least about 30° C., and up to about 40° C., up to about 50° C., or more, such as where the average growth temperature is in a range of about 60° C. to about 140° C., about 70° C. to about 130° C., about 80° C. to about 120° C., about 80° C. to about 100° C., or about 100° C. to about 120° C. It is also contemplated that the seeding temperature can be lower than the growth temperature, such as by increasing a duration of the seeding phase 202 at the lower seeding temperature. Likewise, the growth temperature can be further reduced from the above-specified ranges, such as by increasing a duration of the growth phase 204 at the lower growth temperature.

(4) In the case of a multi-staged reaction, microwave or another mechanism of irradiation can be applied at least during a first stage (encompassing the seeding phase 202) to promote higher yields of nanowires having long lengths. For example, microwave irradiation can be applied at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 30 sec to about 4 hr, about 1 min to about 3 hr, about 5 min to about 3 hr, about 5 min to about 2 hr, about 5 min to about 1 hr, or about 10 min to about 1 hr. For a certain volume of the reaction mixture, a volumetric power density supplied to the reaction mixture through microwave irradiation, or other mechanism of irradiation, can be in a range of about 100 W/L to about 7,500 W/L, about 100 W/L to about 7,000 W/L, about 500 W/L to about 7,500 W/L, about 500 W/L to about 7,000 W/L, about 700 W/L to about 7,000 W/L, or about 700 W/L to about 3,500 W/L, and a volumetric energy density supplied to the reaction mixture through microwave irradiation, or other mechanism of irradiation, over the duration of the reaction can be in a range of about 1.5×10⁴ J/L to about 2.5×10⁸ J/L, about 5×10⁴ J/L to about 10⁸ J/L, about 10⁵ J/L to about 10⁸ J/L, about 5×10⁵ J/L to about 10⁸ J/L, about 10⁶ J/L to about 10⁸ J/L, about 10⁶ J/L to about 5×10⁷ J/L, or about 10⁶ J/L to about 10⁷ J/L. Another mechanism of irradiation, such as infrared, ultraviolet, or visible radiation, or non-radiative heating can be used in place of, or in combination with, microwave irradiation. In some embodiments, it can be desirable to apply a higher power level for a shorter duration of time, or a lower power level for a longer duration of time, depending on a total amount of microwave energy to be applied per unit volume of the reaction mixture. To apply a larger total amount of microwave energy per unit volume, it can be desirable to apply a lower power level for a longer duration of time to promote the formation of desirable nanowire morphologies.

In a second stage (plus any one or more subsequent stages encompassing the growth phase 204), non-radiative heating can be applied to maintain a growth temperature for at least a portion of the growth phase 204 (such as at least about 50%, at least about 60%, at least about 70%, at least about 80%, at least about 90%, or substantially throughout an entire duration of the growth phase 204) in a range of up to about 140° C., up to about 135° C., up to about 130° C., up to about 125° C., up to about 120° C., up to about 115° C., up to about 110° C., up to about 105° C., up to about 100° C., up to about 95° C., or up to about 90° C., and down to about 85° C., down to about 80° C., down to about 70° C., down to about 60° C., or less, and over a duration in a range of at least about 1 hr, at least about 2 hr, at least about 4 hr, at least about 6 hr, at least about 12 hr, at least about 18 hr, at least about 20 hr, or at least about 24 hr, and up to about 30 hr, up to about 36 hr, up to about 42 hr, or more.

(5) A total amount of a metal (e.g., silver) introduced via one or more metal-containing reagents during all stages of the reaction phase 102 can result in an overall concentration of the metal in a reaction mixture (including both ions and in elemental metal form) in a range of up to about 0.2 molar, such as up to about 0.18 molar, up to about 0.16 molar, up to about 0.14 molar, up to about 0.12 molar, up to about 0.11 molar, or up to about 0.1 molar, and down to about 0.04 molar, down to about 0.02 molar, or less. Surprisingly, nanowires having long lengths can be attained even with a relatively low overall concentration of the metal in the reaction mixture of less than about 0.1 molar, such as up to about 0.099 molar, up to about 0.098 molar, up to about 0.097 molar, up to about 0.096 molar, up to about 0.095 molar, up to about 0.09 molar, up to about 0.085 molar, or up to about 0.08 molar, and down to about 0.04 molar, down to about 0.02 molar, or less. A concentration of the metal in the reaction mixture can be expressed in terms of moles of the metal added to the reaction mixture divided by an overall volume of the reaction mixture.

(6) A concentration of each templating agent (e.g., PVP) in a reaction mixture can be in a range of up to about 1 molar, such as up to about 0.9 molar, up to about 0.8 molar, up to about 0.7 molar, up to about 0.6 molar, up to about 0.5 molar, up to about 0.4 molar, up to about 0.35 molar, up to about 0.3 molar, up to about 0.25 molar, or up to about 0.2 molar, and down to about 0.1 molar, down to about 0.05 molar, or less, although higher concentrations greater than about 1 molar are also contemplated. A concentration of the templating agent in the reaction mixture can be expressed in terms of moles of the templating agent added to the reaction mixture divided by an overall volume of the reaction mixture, and, in the case of PVP (or another polymer as the templating agent), moles of the templating agent can be expressed in terms of moles of repeating or monomeric units included in the polymer.

Also, a ratio by moles or concentration of each templating agent (e.g., PVP) to a metal (e.g., silver) in a reaction mixture can be in a range of up to about 20, such as up to about 15, up to about 12, up to about 11, up to about 10, up to about 9.5, up to about 8, up to about 7.5, up to about 7, up to about 6.5, up to about 6, up to about 5.5, up to about 5, up to about 4.5, up to about 4, up to about 3.5, up to about 3, up to about 2.5, up to about 2, or up to about 1.5, and down to about 1.3, down to about 1.2, or less. For example, the ratio of the templating agent to the metal can be in the range of about 2.5 to about 5, can be greater than about 5 and up to about 10, or can be greater than about 2.

To promote the formation of long and thin nanowires, PVP (or another polymer as the templating agent) can have a relatively high average MW, such as an average MW greater than about 55,000, greater than about 100,000, greater than about 200,000, greater than about 300,000, at least about 360,000, at least about 380,000, at least about 400,000, at least about 500,000, at least about 600,000, at least about 700,000, at least about 800,000, at least about 900,000, at least about 1,000,000, at least about 1,100,000, at least about 1,200,000, or at least about 1,300,000, and up to about 1,500,000 or more, up to about 1,700,000 or more, or up to about 1,900,000 or more.

(7) For each SPA that can promote the formation of nanowire-forming seeds or intermediates of nanowire-forming seeds (e.g., KBr, NaBr, or NaCl), a concentration of SPA anions (e.g., halide anions such as Br⁻ or Cl⁻) in a reaction mixture can be in a range of up to about 1 millimolar (or mmolar), up to about 0.5 mmolar, up to about 0.1 mmolar, up to about 0.05 mmolar, up to about 0.01 mmolar, or up to about 0.005 millimolar, and down to about 0.001 mmolar, down to about 0.0005 mmolar, down to about 0.0001 mmolar, or less. A concentration of the SPA anions in the reaction mixture can be expressed in terms of moles of the anions added to the reaction mixture via the SPA (plus via one or more metal-containing reagents if the anions are included in the metal-containing reagents) divided by an overall volume of the reaction mixture.

Also, a ratio by moles or concentration of SPA anions (e.g., halide anions such as Br⁻ or Cl⁻) to a metal (e.g., silver) in a reaction mixture can be in a range of up to about 10, such as less than about 10, up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. For example, the ratio by moles or concentration of the SPA anions (e.g., halide anions such as Br⁻ or Cl⁻) to the metal (e.g., silver) in the reaction mixture can be in the range of about 0.001 to about 10.

Surprisingly, long and thin nanowires can be formed at high yields using KBr (or another bromide or a combination of bromides) alone or substantially devoid of a source of chlorine anions, such as NaCl. As used herein, a reaction mixture (or a reaction medium) can be deemed to be substantially devoid of Cl⁻ if a ratio by moles or concentration of Cl⁻ to a metal (e.g., silver and including both ionic and elemental metal forms) in the reaction mixture is less than about 0.001, such as no greater than about 0.0005, no greater than about 0.0001, no greater than about 0.00005, or no greater than about 0.00001, or if a concentration of Cl⁻ in the reaction mixture is less than about 0.0001 mmolar, such as no greater than about 0.00005 mmolar, no greater than about 0.00001 mmolar, no greater than about 0.000005 mmolar, or no greater than about 0.000001 mmolar. In some embodiments, the use of KBr can provide particular benefits in terms of producing nanowires having small diameters, compared to certain other bromides.

(8) For each SPA that can increase a ratio between nanowire-forming seeds versus non-nanowire-forming seeds (e.g., KNO₃ or NaNO₃) and, thereby, provide higher yields of nanowires, a concentration of SPA anions (e.g., nitrate anions) in a reaction mixture can be in a range of up to about 20 molar, such as up to about 15 molar, up to about 10 molar, up to about 5 molar, up to about 3 molar, up to about 2 molar, up to about 1 molar, up to about 0.9 molar, up to about 0.8 molar, up to about 0.7 molar, up to about 0.6 molar, up to about 0.5 molar, up to about 0.4 molar, up to about 0.35 molar, up to about 0.3 molar, up to about 0.25 molar, or up to about 0.2 molar, and down to about 0.1 molar, down to about 0.05 molar, down to about 0.04 molar, down to about 0.03 molar, down to about 0.02 molar, down to about 0.005 molar, down to about 0.001 molar, or less. A concentration of the SPA anions in the reaction mixture can be expressed in terms of moles of the anions added to the reaction mixture via the SPA (plus via one or more metal-containing reagents if the anions are included in the metal-containing reagents) divided by an overall volume of the reaction mixture.

Also, a ratio by moles or concentration of SPA anions (e.g., nitrate anions) to a metal (e.g., silver) in a reaction mixture can be a non-zero value different from 1, such as a value greater than 1 (e.g., at least 1.01, at least 1.02, at least 1.03, at least 1.04, at least 1.05, or at least 1.1) and up to about 20, up to about 15, up to about 10, up to about 9, up to about 8, up to about 7, up to about 6, up to about 5, up to about 4, up to about 3, up to about 2.5, up to about 2, up to about 1.8, or up to about 1.6, and down to about 1.2, down to about 1.1, or less (but still greater than 1). It is also contemplated that the ratio by moles or concentration of the SPA anions (e.g., nitrate anions) to the metal (e.g., silver) in the reaction mixture can be about 1 or can be a non-zero value less than 1 (e.g., no greater than 0.99, no greater than 0.98, no greater than 0.97, no greater than 0.96, or no greater than 0.95), such as down to about 0.9, down to about 0.7, down to about 0.5, down to about 0.3, down to about 0.1, down to about 0.01, or less. For example, the ratio by moles or concentration of the SPA anions (e.g., nitrate anions) to the metal (e.g., silver) in the reaction mixture can be in the range of about 0.1 to about 20. In some embodiments, the use of KNO₃ can provide particular benefits in terms of producing nanowires having small diameters at high yields, compared to certain other nitrates.

(9) For each first SPA that can promote the formation of nanowire-forming seeds or intermediates of nanowire-forming seeds (e.g., KBr), and each second SPA that can increase a ratio between nanowire-forming seeds versus non-nanowire-forming seeds (e.g., KNO₃), a ratio by moles or concentration of second SPA anions (e.g., nitrate anions) to first SPA anions (e.g., halide anions such as Br⁻) in a reaction mixture can be in a range of up to about 1,000, such as up to about 500, up to about 100, up to about 50, up to about 40, up to about 30, up to about 20, or up to about 10, down to about 5, down to about 1, or less.

Combinations of two or more of the above-specified reaction conditions can be selected for the reaction phase 102 of FIG. 1A to yield unexpected synergistic benefits. For example, long nanowires having small diameters can be attained at a high yield by controlling a combination of reaction conditions including: (i) a moderately elevated pressure (above atmospheric pressure); (ii) microwave or another mechanism of irradiation; (iii) the use of PVP (or another polymer as a templating agent) having a relatively high average MW; and (iv) the use of KBr (or another bromide or a combination of bromides) alone or substantially devoid of a source of chlorine anions; and optionally (v) the use of KNO₃ (or another nitrate or a combination of nitrates).

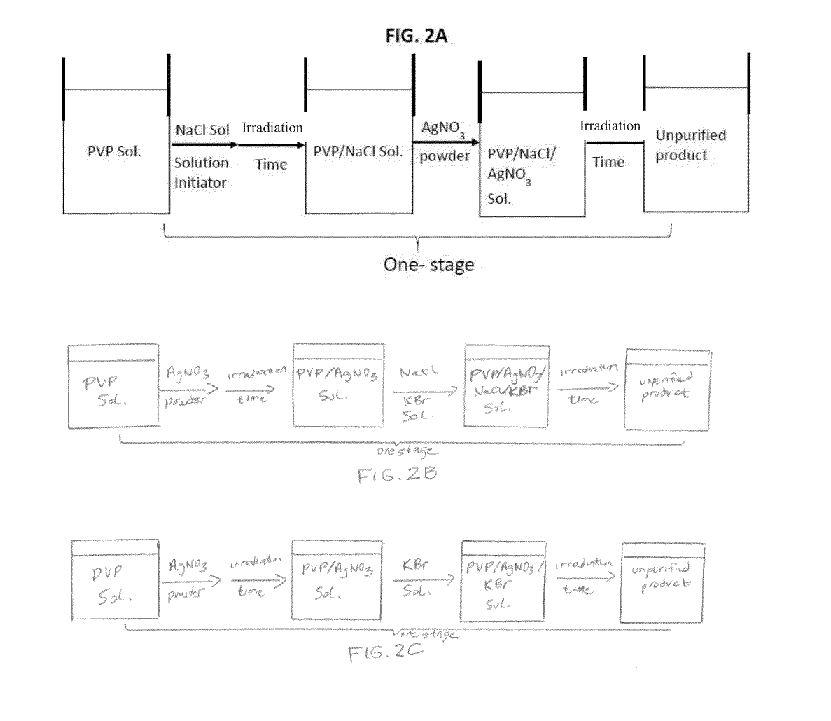

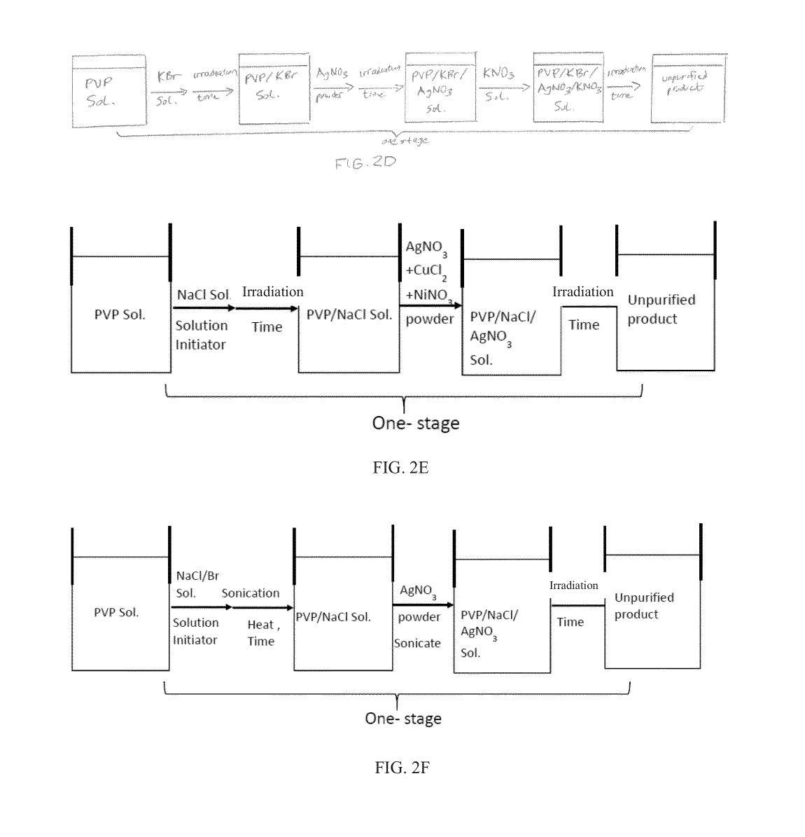

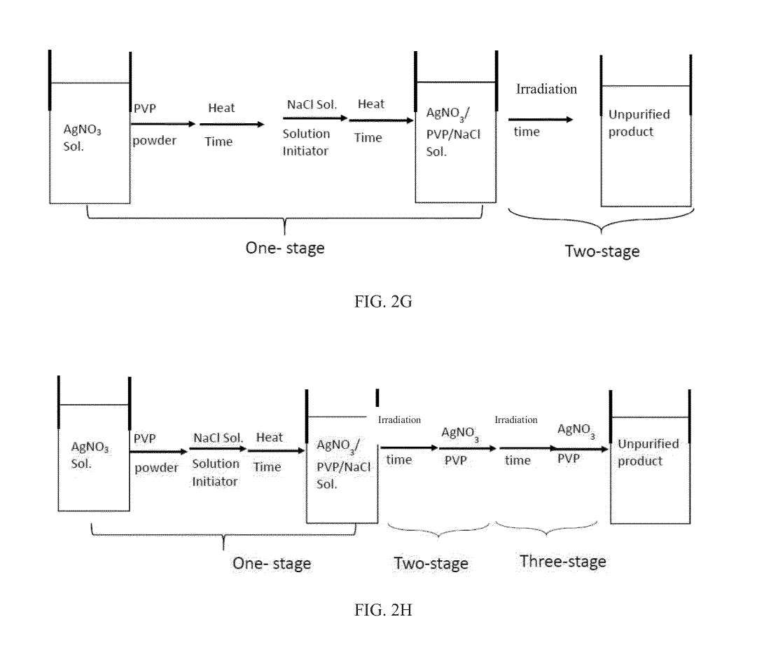

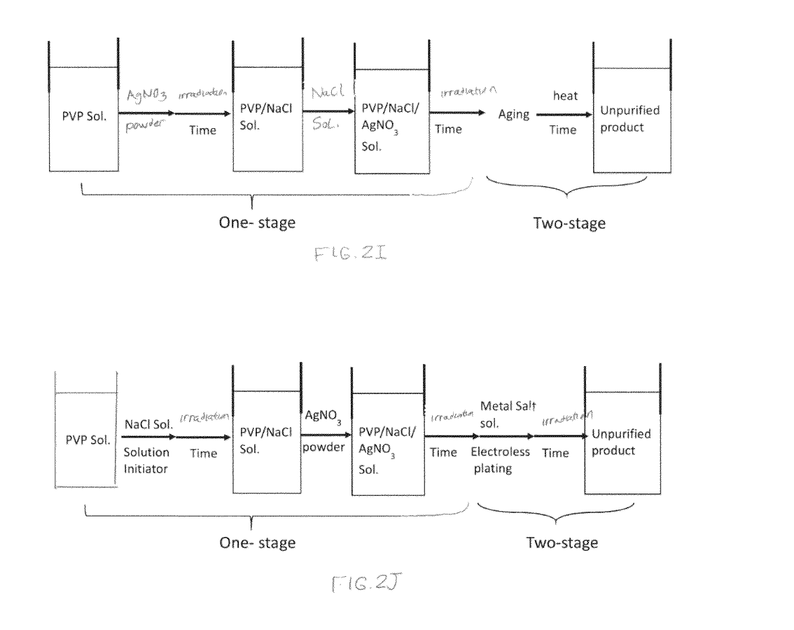

FIG. 2A shows an implementation of a single-staged reaction for the production of silver nanowires. First, a solution of PVP is provided, such as by dispersing or dissolving PVP in glycerol or another suitable solvent. Another templating agent or a combination of different templating agents can be used in place of, or in combination with, PVP. Next, a solution of NaCl in the same or a different solvent is introduced as a SPA. Another SPA or a combination of different SPAs can be used in place of, or in combination with, NaCl. A resulting solution of PVP and NaCl is heated by microwave irradiation at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 5 sec to about 10 min, about 10 sec to about 5 min, about 10 sec to about 4 min, about 10 sec to about 3 min, or about 10 sec to about 2 min. Another mechanism of irradiation, such as infrared, ultraviolet, or visible radiation, or non-radiative heating can be used in place of, or in combination with, microwave irradiation.

Next, AgNO₃ in a solid or semi-solid form, such as a powder, granular, or paste form, is introduced into the PVP and NaCl solution and dispersed or dissolved to form a reaction mixture. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 30 sec to about 8 hr, about 1 min to about 5 hr, about 1 min to about 4 hr, about 5 min to about 4 hr, about 10 min to about 4 hr, about 10 min to about 3 hr, about 10 min to about 2 hr, or about 10 min to about 1 hr, yielding an unpurified product including silver nanowires. For a certain volume of the reaction mixture, a volumetric power density supplied to the reaction mixture through microwave irradiation, or other mechanism of irradiation, can be in a range of about 100 W/L to about 7,500 W/L, about 100 W/L to about 7,000 W/L, about 500 W/L to about 7,500 W/L, about 500 W/L to about 7,000 W/L, about 700 W/L to about 7,000 W/L, or about 700 W/L to about 3,500 W/L, and a volumetric energy density supplied to the reaction mixture through microwave irradiation, or other mechanism of irradiation, over the duration of the reaction can be in a range of about 1.5×10⁴ J/L to about 2.5×10⁸ J/L, about 5×10⁴ J/L to about 10⁸ J/L, about 10⁵ J/L to about 10⁸ J/L, about 5×10⁵ J/L to about 10⁸ J/L, about 10⁶ J/L to about 10⁸ J/L, about 10⁶ J/L to about 5×10⁷ J/L, or about 10⁶ J/L to about 10⁷ J/L. Another mechanism of irradiation, such as infrared, ultraviolet, or visible radiation, or non-radiative heating can be used in place of, or in combination with, microwave irradiation.

FIG. 2B shows another implementation of a single-staged reaction carried out under a positive pressure and where a combination of different SPAs (here, NaCl and KBr) is included for the production of silver nanowires. First, a solution of PVP is provided in a sealed or sealable reactor, such as by dispersing or dissolving PVP in glycerol or another suitable solvent. The reactor is kept sealed, except during introduction of additional reagents. To promote the formation of long and thin silver nanowires, PVP can have a relatively high average MW, such as an average MW greater than about 55,000, greater than about 100,000, greater than about 200,000, greater than about 300,000, greater than about 360,000, at least about 380,000, at least about 400,000, at least about 500,000, at least about 600,000, at least about 700,000, at least about 800,000, at least about 900,000, at least about 1,000,000, at least about 1,100,000, at least about 1,200,000, or at least about 1,300,000, and up to about 1,500,000 or more, up to about 1,700,000 or more, or up to about 1,900,000 or more. Another templating agent or a combination of different templating agents can be used in place of, or in combination with, PVP. Next, AgNO₃ in a solid or semi-solid form, such as a powder, granular, or paste form, is introduced into the PVP solution in the reactor and dispersed or dissolved. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A resulting solution of PVP and AgNO₃ is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Referring to FIG. 2B, a solution of NaCl and KBr in the same or a different solvent is introduced as SPAs to form a reaction mixture. Other SPAs can be used in place of, or in combination with, NaCl and KBr. It is also contemplated that separate solutions of NaCl and KBr can be provided and introduced sequentially or simultaneously into the reaction mixture. A ratio by moles or concentration of Cl⁻ to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. A ratio by moles or concentration of Br⁻ to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding an unpurified product including silver nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

By carrying out the reaction in the sealed reactor as shown in FIG. 2B, the reaction mixture can be subjected to a moderately elevated pressure (above atmospheric pressure) to promote the formation of long and thin silver nanowires at high yields, where the elevated pressure can be in a range of greater than about 14.7 psi (or about 1 atm) and up to about 50 psi (or about 3.4 atm) or more, such as up to about 45 psi (or about 3.1 atm), up to about 40 psi (or about 2.7 atm), up to about 35 psi (or about 2.4 atm), up to about 30 psi (or about 2 atm), up to about 25 psi (or about 1.7 atm), or up to about 20 psi (or about 1.4 atm).

FIG. 2C shows another implementation of a single-staged reaction carried out under a positive pressure and where a SPA (here, KBr alone) is included for the production of silver nanowires. First, a solution of PVP is provided in a sealed or sealable reactor, such as by dispersing or dissolving PVP in glycerol or another suitable solvent. The reactor is kept sealed, except during introduction of additional reagents. To promote the formation of long and thin silver nanowires, PVP can have a relatively high average MW, such as previously explained in connection with FIG. 2B. Another templating agent or a combination of different templating agents can be used in place of, or in combination with, PVP. Next, AgNO₃ in a solid or semi-solid form, such as a powder, granular, or paste form, is introduced into the PVP solution in the reactor and dispersed or dissolved. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A resulting solution of PVP and AgNO₃ is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Referring to FIG. 2C, a solution of KBr in the same or a different solvent is introduced as a SPA to form a reaction mixture. Another bromide or a combination of different bromides can be used in place of, or in combination with, KBr. A ratio by moles or concentration of Br⁻ to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding an unpurified product including silver nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

By carrying out the reaction in the sealed reactor as shown in FIG. 2C, the reaction mixture can be subjected to a moderately elevated pressure (above atmospheric pressure) to promote the formation of long and thin silver nanowires at high yields, where the elevated pressure can be in a range of greater than about 14.7 psi (or about 1 atm) and up to about 50 psi (or about 3.4 atm) or more, such as up to about 45 psi (or about 3.1 atm), up to about 40 psi (or about 2.7 atm), up to about 35 psi (or about 2.4 atm), up to about 30 psi (or about 2 atm), up to about 25 psi (or about 1.7 atm), or up to about 20 psi (or about 1.4 atm). Also, surprisingly and unlike alternative methods, long and thin silver nanowires can be formed at high yields using KBr (or another bromide or a combination of bromides) alone or substantially devoid of a source of chlorine anions, such as NaCl.

FIG. 2D shows another implementation of a single-staged reaction carried out under a positive pressure and where a combination of different SPAs (here, KBr and KNO₃) is included for the production of silver nanowires. First, a solution of PVP is provided in a sealed or sealable reactor, such as by dispersing or dissolving PVP in glycerol or another suitable solvent. The reactor is kept sealed, except during introduction of additional reagents. To promote the formation of long and thin silver nanowires, PVP can have a relatively high average MW, such as previously explained in connection with FIG. 2B. Another templating agent or a combination of different templating agents can be used in place of, or in combination with, PVP. Next, a solution of KBr in the same or a different solvent is introduced as a first SPA. Another bromide or a combination of different bromides can be used in place of, or in combination with, KBr. A resulting solution of PVP and KBr is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Referring to FIG. 2D, AgNO₃ in a solid or semi-solid form, such as a powder, granular, or paste form, is introduced into the PVP and KBr solution in the reactor and dispersed or dissolved. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A resulting solution of PVP, KBr, and AgNO₃ is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Next, as shown in FIG. 2D, a solution of KNO₃ in the same or a different solvent is introduced as a second SPA to form a reaction mixture. Another nitrate or a combination of different nitrates can be used in place of, or in combination with, KNO₃. A ratio by moles or concentration of NO₃⁻ to silver (including both ionic and elemental metal forms) in the reaction mixture can be a non-zero value different from 1, such as a value greater than 1 and up to about 10, up to about 9, up to about 8, up to about 7, up to about 6, up to about 5, up to about 4, up to about 3, up to about 2.5, up to about 2, up to about 1.8, or up to about 1.6, and down to about 1.2, down to about 1.1, or less (but still greater than 1). A ratio by moles or concentration of Br⁻ to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding an unpurified product including silver nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

By carrying out the reaction in the sealed reactor as shown in FIG. 2D, the reaction mixture can be subjected to a moderately elevated pressure (above atmospheric pressure) to promote the formation of long and thin silver nanowires at high yields, where the elevated pressure can be in a range of greater than about 14.7 psi (or about 1 atm) and up to about 50 psi (or about 3.4 atm) or more, such as up to about 45 psi (or about 3.1 atm), up to about 40 psi (or about 2.7 atm), up to about 35 psi (or about 2.4 atm), up to about 30 psi (or about 2 atm), up to about 25 psi (or about 1.7 atm), or up to about 20 psi (or about 1.4 atm). Also, surprisingly and unlike alternative methods, long and thin silver nanowires can be formed at high yields using a combination of SPAs substantially devoid of a source of chlorine anions, such as NaCl.

FIG. 2E shows another implementation of a single-staged reaction where a combination of different metal-containing reagents (here, AgNO₃, CuCl₂, and NiNO₃) are included for the production of metal alloy nanowires (here, nanowires formed of an alloy of silver, copper, and nickel). First, a solution of PVP is provided, such as by dispersing or dissolving PVP in glycerol or another suitable solvent. Another templating agent or a combination of different templating agents can be used in place of, or in combination with, PVP. Next, a solution of NaCl in the same or a different solvent is introduced as a SPA. Another SPA or a combination of different SPAs can be used in place of, or in combination with, NaCl. A resulting solution of PVP and NaCl is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Next, as shown in FIG. 2E, AgNO₃, CuCl₂, and NiNO₃ each in a solid or semi-solid form, such as a powder, granular, or paste form, is introduced into the PVP and NaCl solution and dispersed or dissolved to form a reaction mixture. Other combinations of metal-containing reagents also can be used. It is also contemplated that a solution of AgNO₃, CuCl₂, and NiNO₃ can be provided, and PVP in a solution or a solid or semi-solid form can be introduced into the AgNO₃, CuCl₂, and NiNO₃ solution. A ratio by moles or concentration of Cl⁻ (including contributions from both NaCl and CuCl₂) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding an unpurified product including silver alloy nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation. It is also contemplated that the reaction of FIG. 2E can be carried out under a positive pressure.

FIG. 2F shows another implementation of a single-staged reaction for the production of silver nanowires. First, a solution of PVP is provided, such as by dispersing or dissolving PVP in glycerol or another suitable solvent. Another templating agent or a combination of different templating agents can be used in place of, or in combination with, PVP. Next, a solution of NaCl in the same or a different solvent is introduced as a SPA. Another SPA or a combination of different SPAs can be used in place of, or in combination with, NaCl. Agitation or mixing of the reagents is carried out by applying ultrasound through sonication to form a solution of PVP and NaCl. Sonication also can serve as a non-radiative heating mechanism. Another mechanism of agitation can be used in place of, or in combination with, sonication. Also, another heating mechanism, such as microwave irradiation or non-radiative heating, can be applied in conjunction with sonication.

Next, AgNO₃ in a solid or semi-solid form, such as a powder, granular, or paste form, is introduced into the PVP and NaCl solution and dispersed or dissolved through sonication to form a reaction mixture. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding an unpurified product including silver nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation. It is also contemplated that the reaction of FIG. 2F can be carried out under a positive pressure.

FIG. 2G shows an implementation of a multi-staged reaction for the production of silver nanowires. In a first stage, an AgNO₃ solution is provided, such as by dispersing or dissolving AgNO₃ in glycerol or another suitable solvent. Another silver-containing reagent or a combination of different silver-containing reagents can be used in place of, or in combination with, AgNO₃ during this first stage. Next, PVP in a solid or semi-solid form, such as a powder, granular, or paste form, is introduced into the AgNO₃ solution as a templating agent and dispersed or dissolved under non-radiative heating over a certain duration. Another templating agent or a combination of different templating agents can be used in place of, or in combination with, PVP. It is also contemplated that a PVP solution can be provided, and AgNO₃ in a solution or a solid or semi-solid form can be introduced into the PVP solution. It is further contemplated that irradiation, such as microwave irradiation, can be applied in place of, or in combination with, non-radiative heating. Next, a solution of NaCl in the same or a different solvent is introduced as a SPA to form a reaction mixture. Another SPA or a combination of different SPAs can be used in place of, or in combination with, NaCl. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. In this first stage, the reaction mixture is subjected to non-radiative heating at a certain reaction temperature or a sequence of different reaction temperatures, such as in a range of less than about 110° C., up to about 109° C., up to about 108° C., up to about 107° C., up to about 106° C., up to about 105° C., up to about 104° C., up to about 103° C., up to about 102° C., up to about 101° C., up to about 100° C., up to about 99° C., up to about 98° C., up to about 97° C., up to about 96° C., up to about 95° C., up to about 90° C., up to about 85° C., up to about 80° C., or up to about 75° C., and down to about 60° C., down to about 50° C., down to about 40° C., or less, and over a certain duration, such as in a range of at least about 1 hr, at least about 2 hr, at least about 4 hr, at least about 6 hr, at least about 12 hr, at least about 18 hr, at least about 20 hr, or at least about 24 hr, and up to about 30 hr, up to about 36 hr, up to about 42 hr, or more. During this first stage, silver nanowires can form from the reaction mixture in a self-seeding process, with lengths that are typically shorter than their final desired lengths.

In a second stage, the reaction mixture is heated by microwave irradiation at a certain power level or a sequence of different power levels, at a certain frequency or a sequence of different frequencies, and over a certain duration. During this second stage, silver nanowire growth is largely or substantially in the axial direction, thereby yielding an unpurified product including long silver nanowires having small diameters. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation. It is also contemplated that the second stage of FIG. 2G can be carried out under a positive pressure.

FIG. 2H shows another implementation of a multi-staged reaction for the production of silver nanowires. In a first stage, an AgNO₃ solution is provided, such as by dispersing or dissolving a first amount of AgNO₃ in glycerol or another suitable solvent. Another silver-containing reagent or a combination of different silver-containing reagents can be used in place of, or in combination with, AgNO₃ during this first stage. Next, PVP in a solid or semi-solid form, such as a powder, granular, or paste form, is introduced into the AgNO₃ solution as a templating agent and dispersed or dissolved. Another templating agent or a combination of different templating agents can be used in place of, or in combination with, PVP. It is also contemplated that a PVP solution can be provided, and AgNO₃ in a solution or a solid or semi-solid form can be introduced into the PVP solution. Next, a solution of NaCl in the same or a different solvent is introduced as a SPA to form a reaction mixture. Another SPA or a combination of different SPAs can be used in place of, or in combination with, NaCl. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. In this first stage, the reaction mixture is subjected to non-radiative heating at a certain reaction temperature or a sequence of different reaction temperatures, and over a certain duration. Non-radiative heating can be carried out under conditions that are the same or similar to those previously explained in connection with FIG. 2G. During this first stage, silver nanowires can form from the reaction mixture in a self-seeding process, with lengths that are typically shorter than their final desired lengths.

In a second stage, the reaction mixture is heated by microwave irradiation at a certain power level or a sequence of different power levels, at a certain frequency or a sequence of different frequencies, and over a certain duration. During this second stage, a second amount of AgNO₃ is introduced into the reaction mixture as a solution, along with an amount of a PVP solution that can be introduced simultaneously or sequentially into the reaction mixture. Another silver-containing reagent or a combination of different silver-containing reagents can be used in place of, or in combination with, AgNO₃ during this second stage. Also, another templating agent or a combination of different templating agents can be used in place of, or in combination with, PVP during this second stage.

In a third stage, the reaction mixture is heated by microwave irradiation at a certain power level or a sequence of different power levels, at a certain frequency or a sequence of different frequencies, and over a certain duration. During this third stage, a third amount of AgNO₃ is introduced into the reaction mixture as a solution, along with an amount of a PVP solution that can be introduced simultaneously or sequentially into the reaction mixture. Another silver-containing reagent or a combination of different silver-containing reagents can be used in place of, or in combination with, AgNO₃ during this third stage. Also, another templating agent or a combination of different templating agents can be used in place of, or in combination with, PVP during this third stage.

During the second and third stages, silver nanowire growth is largely or substantially in the axial direction, thereby yielding an unpurified product including long silver nanowires having small diameters. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation. It is also contemplated that either, or both, the second and third stages of FIG. 2H can be carried out under a positive pressure. Although three stages are shown in the multi-staged implementation of FIG. 2H, other multi-staged implementations, in general, can have two or more stages, such as three stages, four stages, five stages, six stages, or more, including any type of continuous stage. Also, it is contemplated that a SPA or a combination of different SPAs can be introduced during any one or more of the stages following the first stage.

FIG. 2I shows another implementation of a multi-staged reaction for the production of silver nanowires. In a first stage, a solution of PVP is provided, such as by dispersing or dissolving PVP in glycerol or another suitable solvent. Another templating agent or a combination of different templating agents can be used in place of, or in combination with, PVP. Next, AgNO₃ in a solid or semi-solid form, such as a powder, granular, or paste form, is introduced into the PVP solution and dispersed or dissolved under microwave irradiation. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. Next, a solution of NaCl in the same or a different solvent is introduced as a SPA to form a reaction mixture. Another SPA or a combination of different SPAs can be used in place of, or in combination with, NaCl. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. In this first stage, the reaction mixture is heated by microwave irradiation at a certain power level or a sequence of different power levels, such as in a range of about 50 W to about 2,000 W, about 50 W to about 1,500 W, about 50 W to about 700 W, about 70 W to about 700 W, or about 70 W to about 350 W, at a certain frequency or a sequence of different frequencies, such as in a range of about 0.3 GHz to about 300 GHz, about 0.3 GHz to about 30 GHz, about 0.3 GHz to about 10 GHz, about 0.3 GHz to about 5 GHz, or about 2.45 GHz, and over a certain duration, such as in a range of about 30 sec to about 4 hr, about 1 min to about 3 hr, about 5 min to about 3 hr, about 5 min to about 2 hr, about 5 min to about 1 hr, or about 10 min to about 1 hr. Another mechanism of irradiation, such as infrared, ultraviolet, or visible radiation, or non-radiative heating can be used in place of, or in combination with, microwave irradiation. It is also contemplated that the first stage of FIG. 2I can be carried out under a positive pressure. During this first stage, a seeding process occurs to form seeds, including nanowire-forming seeds.

In a second stage, the reaction mixture is subjected to non-radiative heating at a certain reaction temperature or a sequence of different reaction temperatures, such as in a range of up to about 140° C., up to about 135° C., up to about 130° C., up to about 125° C., up to about 120° C., up to about 115° C., up to about 110° C., up to about 105° C., up to about 100° C., up to about 95° C., or up to about 90° C., and down to about 85° C., down to about 80° C., down to about 70° C., down to about 60° C., or less, and over a certain duration, such as in a range of at least about 1 hr, at least about 2 hr, at least about 4 hr, at least about 6 hr, at least about 12 hr, at least about 18 hr, at least about 20 hr, or at least about 24 hr, and up to about 30 hr, up to about 36 hr, up to about 42 hr, or more. During this second stage, silver nanowires can grow from the seeds largely or substantially in the axial direction, thereby yielding an unpurified product including long silver nanowires having small diameters.

FIG. 2J shows another implementation of a multi-staged reaction for the production of nanowires having a core-shell configuration (here, nanowires each including a core formed of silver and surrounded by a shell formed of a metal different from silver). In a first stage, a solution of PVP is provided, such as by dispersing or dissolving PVP in glycerol or another suitable solvent. Another templating agent or a combination of different templating agents can be used in place of, or in combination with, PVP. Next, a solution of NaCl in the same or a different solvent is introduced as a SPA. Another SPA or a combination of different SPAs can be used in place of, or in combination with, NaCl. A resulting solution of PVP and NaCl is heated by microwave irradiation at a certain power level or a sequence of different power levels, at a certain frequency or a sequence of different frequencies, and over a certain duration. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

Next, AgNO₃ in a solid or semi-solid form, such as a powder, granular, or paste form, is introduced into the PVP and NaCl solution and dispersed or dissolved to form a reaction mixture. Another silver-containing reagent or a combination of different silver-containing reagents can be used in place of, or in combination with, AgNO₃. It is also contemplated that an AgNO₃ solution can be provided, and PVP in a solution or a solid or semi-solid form can be introduced into the AgNO₃ solution. A ratio by moles or concentration of Cl⁻ (or other halide anion) to silver (including both ionic and elemental metal forms) in the reaction mixture can be in a range of up to about 10, such as up to about 5, up to about 3, up to about 2.5, up to about 2, up to about 1.5, up to about 1, up to about 0.5, up to about 0.25, up to about 0.1, up to about 0.05, up to about 0.01, or up to about 0.005, and down to about 0.002, down to about 0.001, or less. The reaction mixture is heated by microwave irradiation at a certain power level or a sequence of different power levels, at a certain frequency or a sequence of different frequencies, and over a certain duration, yielding silver nanowires. Microwave irradiation can be applied under conditions that are the same or similar to those previously explained in connection with FIG. 2A. Another mechanism of irradiation, such as infrared, ultraviolet, or visible radiation, or non-radiative heating can be used in place of, or in combination with, microwave irradiation.

In a second stage, a solution of a metal-containing reagent in the same or a different solvent is introduced, where the metal-containing reagent is a source of a metal different from silver. The reaction mixture is heated by microwave irradiation at a certain power level or a sequence of different power levels, at a certain frequency or a sequence of different frequencies, and over a certain duration. During this second stage, the formation of shells surrounding the silver nanowires can occur via microwave-assisted electroless plating, thereby yielding core-shell nanowires. Microwave irradiation can be applied under conditions that are the same or similar to those used to synthesize silver nanowires in the first stage and as previously explained in connection with FIG. 2A. Another mechanism of irradiation, such as infrared, ultraviolet, or visible radiation, or non-radiative heating can be used in place of, or in combination with, microwave irradiation.

Referring back to FIG. 1A, the unpurified product from the reaction phase 102 can be purified in the purification phase 104. The purification phase 104 can result in a higher percentage by number of nanowires relative to all nanostructures and microstructures (including all nanostructures other than nanowires) compared to a percentage by number of nanowires in the unpurified product. Specifically, synthesized nanowires can be separated from other components of a reaction mixture using any one or a combination of different techniques such as gravity sedimentation, centrifugation, and cross-flow filtration, and then re-dispersed in a suitable liquid to form a nanowire composition, such as a nanowire dispersion. If the nanowire dispersion is determined to have an unacceptable level of agglomerates, the nanowire dispersion can be subjected to a procedure for agglomerate removal.

In some embodiments, a reaction mixture can be quenched or otherwise cooled to a desired temperature, such as about room temperature. Next, the cooled reaction mixture can be mixed or otherwise combined with at least one re-dispersal liquid, and a solid product (including nanowires) can be permitted to settle. In some embodiments, the settled product is the desired product, so the supernatant is removed, and the settled product is kept. In other embodiments, the settled product is the undesired product, so the supernatant is removed and kept, and the settled product is disposed or recycled. The settled product can be separated by decanting or otherwise removing a supernatant, and then re-dispersed in the same liquid or another re-dispersal liquid, optionally with agitation to remove remaining components of the reaction mixture. This settle-wash process can be repeated one or more times, resulting in a dispersion of nanowires in a suitable liquid. In other embodiments, a hot, as-synthesized reaction mixture can be quenched by directly mixing or otherwise combining with a cooled re-dispersal liquid. After such quenching, other aspects of a settle-wash process can be similarly carried out as described above. Settling as described herein can include gravity settling, centrifugation, or any other similar technique. A resulting dispersion of nanowires in a re-dispersal liquid can be placed in a suitable container for shipping and storage.

Examples of suitable re-dispersal liquids include single solvents or combinations of different solvents, such as selected from alcohols (e.g., primary, secondary, and tertiary alcohols including from 1 to 10, 1 to 8, 1 to 5, 1 to 4, 1 to 3, or 2 to 3 carbon atoms), water, hydrocarbons (e.g., paraffins, hydrogenated hydrocarbons, and cycloaliphatic hydrocarbons), alkenes, alkynes, aldehydes, ketones (e.g., cyclic ketones), ethers, and combinations thereof. By way of example, nanowires can be re-dispersed in isopropanol, methanol, ethanol, water, or a combination thereof. Other specific examples of suitable solvents include 2-methyltetrahydrofuran, a chloro-hydrocarbon, a fluoro-hydrocarbon, acetaldehyde, acetic acid, acetic anhydride, acetone, acetonitrile, aniline, benzene, benzonitrile, benzyl alcohol, benzyl ether, butanol, butanone, butyl acetate, butyl ether, butyl formate, butyraldehyde, butyric acid, butyronitrile, carbon disulfide, carbon tetrachloride, chlorobenzene, chlorobutane, chloroform, cyclohexane, cyclohexanol, cyclopentanone, cyclohexanone, cyclopentyl methyl ether, diacetone alcohol, dichloroethane, dichloromethane, diethyl carbonate, diethyl ether, diethylene glycol, diglyme, di-isopropylamine, dimethoxyethane, dimethyl formamide, dimethyl sulfoxide, dimethylamine, dimethylbutane, dimethylether, dimethylformamide, dimethylpentane, dimethylsulfoxide, dioxane, dodecafluoro-1-hepatanol, ethanol, ethyl acetate, ethyl ether, ethyl formate, ethyl propionate, ethylene dichloride, ethylene glycol, formamide, formic acid, glycerine, heptane, hexafluoroisopropanol, hexamethylphosphoramide, hexamethylphosphorous triamide, hexane, hexanone, hydrogen peroxide, hypochlorite, i-butyl acetate, i-butyl alcohol, i-butyl formate, i-butylamine, i-octane, i-propyl acetate, i-propyl ether, isopropanol, isopropylamine, ketone peroxide, methanol and calcium chloride solution, methoxyethanol, methoxyphenol, methyl acetate, methyl ethyl ketone, methyl isobutyl ketone, methyl formate, methyl n-butyrate, methyl n-propyl ketone, methyl t-butyl ether, methylene chloride, methylene, methylhexane, methylpentane, mineral oil, m-xylene, n-butanol, n-decane, n-hexane, nitrobenzene, nitroethane, nitromethane, nitropropane, N-methyl-2-pyrrolidinone, n-propanol, octafluoro-1-pentanol, octane, pentane, pentanol, pentanone, petroleum ether, phenol, propanol, propionaldehyde, propionic acid, propionitrile, propyl acetate, propyl ether, propyl formate, propylamine, p-xylene, pyridine, pyrrolidine, salicylaldehyde, sodium hydroxide, sodium-containing solution, t-butanol, t-butyl alcohol, t-butyl methyl ether, tetrachloroethane, tetrafluoropropanol, tetrahydrofuran, tetrahydronaphthalene, toluene, triethyl amine, trifluoroacetic acid, trifluoroethanol, trifluoropropanol, trimethylbutane, trimethylhexane, trimethylpentane, valeronitrile, xylene, xylenol, and other similar compounds or solutions and any combination thereof.

More generally, a re-dispersal liquid can include water, an ionic or ion-containing solution, an ionic liquid, an organic solvent (e.g., a polar, organic solvent; a non-polar, organic solvent; an aprotic solvent; a protic solvent; a polar aprotic solvent, or a polar, protic solvent); an inorganic solvent, or any combination thereof. Oils also can be considered suitable solvents.

Prior to the purification phase 104, a certain amount of a templating agent (e.g., PVP) in the unpurified product can be bound to surfaces or crystal faces of synthesized nanowires, with a remaining amount of the templating agent being unbound and freely dispersed in the reaction mixture. Subsequent to the purification phase 104, a certain amount of the templating agent (e.g., PVP) in the purified product can remain bound to surfaces or crystal faces of synthesized nanowires, with potentially a residual or trace amount of the templating agent being unbound and freely dispersed in a re-dispersal solvent. The presence of such surface-bound templating agent can be beneficial in stabilizing or solubilizing the nanowires in the re-dispersal solvent, such that the addition of stabilizers or surfactants can be omitted. In the case of applications for TCEs, for example, the inclusion of additional stabilizers or surfactants can lead to higher cost of manufacturing, and can negatively impact electrical and optical characteristics of the TCEs.

By carrying out the production of nanowires according to embodiments of this disclosure, a number of benefits can be attained. For example, a yield of nanowires in the unpurified or purified product can be at least about 70% for small scale reactions (e.g., a reaction mixture volume up to about 1 L), such as at least about 75%, at least about 80%, at least about 85%, at least about 87%, at least about 90%, or at least about 92%, and up to about 95%, up to about 98%, or more, and a yield of nanowires in the unpurified or purified product can be at least about 55% for large scale reactions (e.g., a reaction mixture volume greater than about 1 L), such as at least about 60%, at least about 65%, at least about 70%, at least about 75%, or at least about 80%, and up to about 85%, up to about 90%, or more. As used herein, a yield of nanowires formed of a material can refer to an amount (e.g., by weight or moles) of the nanowires relative to an amount (e.g., by weight or moles) of the material added to a reaction mixture in the form of a set of reagents. Additionally, a yield of conversion of silver ions to silver metal can be at least about 99% (e.g., by weight or moles), at least about 98%, at least about 97%, at least about 96% at least about 95%, at least about 94%, at least about 93%, at least about 92%, at least about 91%, at least about 90%, at least about 89%, at least about 88%, at least about 87%, at least about 86%, at least about 85%, or at least about 80%.

As another example, a percentage by number of nanowires relative to all nanostructures and microstructures (including all nanostructures other than nanowires), or relative to all solids or particulate material, in the unpurified product can be at least about 1%, such as at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, or at least about 80%, and up to about 85%, up to about 90%, up to about 95%, or more, and a percentage by number of nanowires relative to all nanostructures and microstructures (including all nanostructures other than nanowires) in the purified product can be at least about 50%, such as at least about 55%, at least about 60%, at least about 65%, at least about 70%, at least about 75%, at least about 80%, at least about 85%, or at least about 90%, and up to about 95%, up to about 98%, up to about 99%, or more. As used herein, a percentage by number of nanowires in an unpurified or a purified product can be based on manual or automated inspection of one or more imaged samples, and can be calculated relative to a sample size of nanostructures and microstructures in the imaged samples of at least 50, at least 100, at least 500, or at least 1,000.

As another example, a percentage by number of nanowire-forming seeds relative to all nanostructures and microstructures (including all seeds other than nanowire-forming seeds), or relative to all solids or particulate material, in the unpurified product can be at least about 1%, such as at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, or at least about 80%, and up to about 85%, up to about 90%, up to about 95%, or more, and a percentage by number of nanowire-forming seeds relative to all nanostructures and microstructures (including all seeds other than nanowire-forming seeds) in the purified product can be at least about 50%, such as at least about 55%, at least about 60%, at least about 65%, at least about 70%, at least about 75%, at least about 80%, at least about 85%, or at least about 90%, and up to about 95%, up to about 98%, up to about 99%, or more. As used herein, a percentage by number of nanowire-forming seeds in an unpurified or a purified product can be based on manual or automated inspection of one or more imaged samples, and can be calculated relative to a sample size of nanostructures and microstructures in the imaged samples of at least 50, at least 100, at least 500, or at least 1,000.

As another example, among nanowires in the unpurified or purified product, at least about 30% of the nanowires (e.g., by number) can have an aspect ratio of at least about 50, such as at least about 35%, at least about 40%, at least about 45%, at least about 50%, at least about 55%, at least about 60%, at least about 65%, or at least about 60%, and up to about 80%, up to about 90%, or more. In some implementations, at least about 25% of the nanowires (e.g., by number) can have an aspect ratio of at least about 100, such as at least about 30%, at least about 35%, at least about 40%, at least about 45%, at least about 50%, at least about 55%, at least about 60%, or at least about 65%, and up to about 75%, up to about 85%, or more. In other implementations, at least about 20% of the nanowires (e.g., by number) can have an aspect ratio of at least about 200, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have an aspect ratio of at least about 400, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have an aspect ratio of at least about 500, such as at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have an aspect ratio of at least about 600, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 700, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 800, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 900, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,000, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,100, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,200, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,300, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,400, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 1,500, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 2,000, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have an aspect ratio of at least about 5,000, such as at least about 15%, at least about 20%, at least about 25%, at least about 30%, at least about 35%, at least about 40%, at least about 45%, or at least about 50%, and up to about 60%, up to about 70%, or more. In other implementations, at least about 5% of the nanowires (e.g., by number) can have an aspect ratio of at least about 10,000, such as at least about 10%, at least about 15%, at least about 20%, at least about 25%, at least about 30%, at least about 35%, at least about 40%, or at least about 45%, and up to about 55%, up to about 65%, or more. As used herein, a percentage by number of nanowires in an unpurified or a purified product having a specified aspect ratio can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average aspect ratio of the nanowires can be in a range of about 50 to about 10,000, such as from about 100 to about 10,000, from about 5,000 to about 10,000, from about 3,000 to about 10,000, from about 100 to about 2,000, from about 200 to about 2,000, from about 400 to about 2,000, from about 400 to about 1,500, from about 400 to about 1,000, from about 500 to about 1,000, from about 100 to about 3,000, from about 200 to about 3,000, from about 400 to about 3,000, from about 500 to about 3,000, from about 1,000 to about 3,000, from about 1,500 to about 3,000, from about 2,000 to about 3,000, from about 100 to about 5,000, from about 200 to about 5,000, from about 400 to about 5,000, from about 500 to about 5,000, from about 1,000 to about 5,000, from about 1,500 to about 5,000, from about 2,000 to about 5,000, from about 2,500 to about 5,000, from about 3,000 to about 5,000, from about 3,500 to about 5,000, or from about 4,000 to about 5,000, and a distribution of aspect ratios of the nanowires can be uniform or highly uniform with a standard deviation in the range of about 10 to about 1,000, such as from about 10 to about 900, from about 10 to about 800, from about 10 to about 700, from about 10 to about 600, from about 10 to about 500, from about 10 to about 450, from about 10 to about 400, from about 50 to about 350, from about 50 to about 300, or from about 50 to about 250. As used herein, an average aspect ratio and a distribution of aspect ratios of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average aspect ratio of the nanowires can be at least about 50, at least about 100, at least about 200, at least about 400, at least about 500, at least about 600, at least about 700, at least about 800, at least about 900, at least about 1,000, at least about 1,100, at least about 1,200, at least about 1,300, at least about 1,400, at least about 1,500, at least about 2,000, at least about 3,000, or at least about 4,000, and up to about 5,000, up to about 10,000, or more, and a distribution of aspect ratios of the nanowires can be uniform or highly uniform with a standard deviation in the range of about 10 to about 1,000, such as from about 10 to about 900, from about 10 to about 800, from about 10 to about 700, from about 10 to about 600, from about 10 to about 500, from about 10 to about 450, from about 10 to about 400, from about 50 to about 350, from about 50 to about 300, or from about 50 to about 250. As used herein, an average aspect ratio and a distribution of aspect ratios of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, at least about 30% of the nanowires (e.g., by number) can have a length of at least about 5 μm, such as at least about 35%, at least about 40%, at least about 45%, at least about 50%, at least about 55%, at least about 60%, at least about 65%, or at least about 60%, and up to about 80%, up to about 90%, or more. In some implementations, at least about 30% of the nanowires (e.g., by number) can have a length of at least about 8 82 m, such as at least about 35%, at least about 40%, at least about 45%, at least about 50%, at least about 55%, at least about 60%, at least about 65%, or at least about 60%, and up to about 80%, up to about 90%, or more. In other implementations, at least about 25% of the nanowires (e.g., by number) can have a length of at least about 10 μm, such as at least about 30%, at least about 35%, at least about 40%, at least about 45%, at least about 50%, at least about 55%, at least about 60%, or at least about 65%, and up to about 75%, up to about 85%, or more. In other implementations, at least about 25% of the nanowires (e.g., by number) can have a length of at least about 13 μm, such as at least about 30%, at least about 35%, at least about 40%, at least about 45%, at least about 50%, at least about 55%, at least about 60%, or at least about 65%, and up to about 75%, up to about 85%, or more. In other implementations, at least about 10% of the nanowires (e.g., by number) can have a length of at least about 15 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 17 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 20 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 25 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 30 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 35 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 40 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 45 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 50 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 55 μm, such as at least about 15%, at least about 20%, at least about 25%, at least about 30%, at least about 35%, at least about 40%, at least about 45%, or at least about 50%, and up to about 60%, up to about 70%, or more. In other implementations, at least about 10% of the nanowires (e.g., by number) can have a length of at least about 60 μm, such as at least about 15%, at least about 20%, at least about 25%, at least about 30%, at least about 35%, at least about 40%, at least about 45%, or at least about 50%, and up to about 60%, up to about 70%, or more. As used herein, a percentage by number of nanowires in an unpurified or a purified product having a specified length can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average length of the nanowires can be in a range of about 5 μm to about 100 μm, such as from about 5 μm to about 8 μm, from about 8 μm to about 100 μm, from about 10 μm to about 100 μm, from about 10 μm to about 80 μm, from about 10 μm to about 60 μm, from about 10 μm to about 50 μm, from about 10 μm to about 45 μm, from about 10 μm to about 40 μm, from about 10 μm to about 35 μm, from about 10 μm to about 30 μm, from about 10 μm to about 25 μm, from about 10 μm to about 20 μm, from about 10 μm to about 15 μm, from about 15 μm to about 100 μm, from about 15 μm to about 80 μm, from about 15 μm to about 60 μm, from about 15 μm to about 50 μm, from about 15 μm to about 45 μm, from about 15 μm to about 40 μm, from about 15 μm to about 35 μm, from about 15 μm to about 30 μm, from about 20 μm to about 100 μm, from about 20 μm to about 80 μm, from about 20 μm to about 60 μm, from about 20 μm to about 50 μm, from about 20 μm to about 45 μm, from about 25 μm to about 60 μm, from about 25 μm to about 50 μm, from about 25 μm to about 45 μm, from about 30 μm to about 60 μm, from about 30 μm to about 50 μm, from about 30 μm to about 45 μm, from about 35 μm to about 60 μm, from about 35 μm to about 50 μm, or from about 35 μm to about 45 μm, and a distribution of lengths of the nanowires can be uniform or highly uniform with a standard deviation in the range of about 1 μm to about 40 μm, such as from about 1 μm to about 30 μm, from about 1 μm to about 25 μm, from about 1 μm to about 20 μm, from about 1 μm to about 15 μm, from about 1 μm to about 10 μm, from about 5 μm to about 20 μm, from about 5 μm to about 15 μm, from about 5 μm to about 10 μm, or from about 1 μm to about 5 μm, or, when expressed as a percentage of the average length, the standard deviation can be in the range of about 1% to about 99%, such as from about 5% to about 95%, from about 5% to about 90%, from about 5% to about 80%, from about 5% to about 70%, from about 5% to about 60%, from about 5% to about 50%, from about 10% to about 95%, from about 10% to about 90%, from about 10% to about 80%, from about 10% to about 70%, from about 10% to about 60%, from about 10% to about 50%, from about 20% to about 95%, from about 20% to about 90%, from about 20% to about 80%, from about 20% to about 70%, from about 20% to about 60%, from about 20% to about 50%, from about 30% to about 95%, from about 30% to about 90%, from about 30% to about 80%, from about 30% to about 70%, from about 30% to about 60%, from about 30% to about 50%, from about 40% to about 95%, from about 40% to about 90%, from about 40% to about 80%, from about 40% to about 70%, from about 40% to about 60%, from about 40% to about 50%, from about 50% to about 95%, from about 50% to about 90%, from about 50% to about 80%, from about 50% to about 70%, from about 50% to about 60%, from about 50% to about 50%, from about 60% to about 95%, from about 60% to about 90%, from about 60% to about 80%, or from about 60% to about 70%. As used herein, an average length and a distribution of lengths of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average length of the nanowires can be at least about 5 μm, at least about 8 μm, at least about 10 μm, at least about 13 μm, at least about 15 μm, at least about 17 μm, at least about 20 μm, at least about 25 μm, at least about 30 μm, at least about 35 μm, at least about 40 μm, at least about 45 μm, at least about 50 μm, or at least about 55 μm, and up to about 60 μm, up to about 100 μm, or more, and a distribution of lengths of the nanowires can be uniform or highly uniform with a standard deviation in the range of about 1 μm to about 40 μm, such as from about 1 μm to about 30 μm, from about 1 μm to about 25 μm, from about 1 μm to about 20 μm, from about 1 μm to about 15 μm, from about 1 μm to about 10 μm, from about 5 μm to about 20 μm, from about 5 μm to about 15 μm, from about 5 μm to about 10 μm, or from about 1 μm to about 5 μm, or, when expressed as a percentage of the average length, the standard deviation can be in the range of about 1% to about 99%, such as from about 5% to about 95%, from about 5% to about 90%, from about 5% to about 80%, from about 5% to about 70%, from about 5% to about 60%, from about 5% to about 50%, from about 10% to about 95%, from about 10% to about 90%, from about 10% to about 80%, from about 10% to about 70%, from about 10% to about 60%, from about 10% to about 50%, from about 20% to about 95%, from about 20% to about 90%, from about 20% to about 80%, from about 20% to about 70%, from about 20% to about 60%, from about 20% to about 50%, from about 30% to about 95%, from about 30% to about 90%, from about 30% to about 80%, from about 30% to about 70%, from about 30% to about 60%, from about 30% to about 50%, from about 40% to about 95%, from about 40% to about 90%, from about 40% to about 80%, from about 40% to about 70%, from about 40% to about 60%, from about 40% to about 50%, from about 50% to about 95%, from about 50% to about 90%, from about 50% to about 80%, from about 50% to about 70%, from about 50% to about 60%, from about 50% to about 50%, from about 60% to about 95%, from about 60% to about 90%, from about 60% to about 80%, or from about 60% to about 70%. As used herein, an average length and a distribution of lengths of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, at least about 30% of the nanowires (e.g., by number) can have a diameter no greater than about 100 nm, such as at least about 35%, at least about 40%, at least about 45%, at least about 50%, at least about 55%, at least about 60%, at least about 65%, or at least about 60%, and up to about 80%, up to about 90%, or more. In some implementations, at least about 25% of the nanowires (e.g., by number) can have a diameter no greater than about 60 nm, such as at least about 30%, at least about 35%, at least about 40%, at least about 45%, at least about 50%, at least about 55%, at least about 60%, or at least about 65%, and up to about 75%, up to about 85%, or more. In other implementations, at least about 20% of the nanowires (e.g., by number) can have a diameter no greater than about 50 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have a diameter no greater than about 40 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have a diameter no greater than about 35 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have a diameter no greater than about 33 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have a diameter no greater than about 30 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 20% of the nanowires (e.g., by number) can have a diameter no greater than about 27 nm, such as at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 25 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 23 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 20 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 17 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 15 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 13 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 10 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 5 nm, such as at least about 20%, at least about 25%, at least about 30%, at least about 35%, at least about 40%, at least about 45%, at least about 50%, at least about 55%, or at least about 60%, and up to about 70%, up to about 80%, or more. In other implementations, at least about 10% of the nanowires (e.g., by number) can have a diameter no greater than about 3 nm, such as at least about 20%, at least about 25%, at least about 30%, at least about 35%, at least about 40%, at least about 45%, at least about 50%, at least about 55%, or at least about 60%, and up to about 70%, up to about 80%, or more. As used herein, a percentage by number of nanowires in an unpurified or a purified product having a specified diameter can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average diameter of the nanowires can be in the range of about 3 nm to about 100 nm, such as from about 3 nm to about 100 nm, from about 3 nm to about 80 nm, from about 3 nm to about 70 nm, from about 3 nm to about 60 nm, from about 3 nm to about 50 nm, from about 3 nm to about 45 nm, from about 3 nm to about 40 nm, from about 3 nm to about 35 nm, from about 3 nm to about 30 nm, from about 3 nm to about 25 nm, from about 3 nm to about 20 nm, from about 3 nm to about 15 nm, from about 3 nm to about 10 nm, from about 5 nm to about 100 nm, from about 5 nm to about 80 nm, from about 5 nm to about 70 nm, from about 5 nm to about 60 nm, from about 5 nm to about 50 nm, from about 5 nm to about 45 nm, from about 5 nm to about 40 nm, from about 5 nm to about 35 nm, from about 5 nm to about 30 nm, from about 5 nm to about 25 nm, from about 5 nm to about 20 nm, from about 5 nm to about 15 nm, from about 10 nm to about 100 nm, from about 10 nm to about 80 nm, from about 10 nm to about 70 nm, from about 10 nm to about 60 nm, from about 10 nm to about 50 nm, from about 10 nm to about 45 nm, from about 10 nm to about 40 nm, from about 10 nm to about 35 nm, from about 10 nm to about 30 nm, from about 10 nm to about 25 nm, from about 10 nm to about 20 nm, from about 20 nm to about 60 nm, from about 20 nm to about 50 nm, from about 20 nm to about 45 nm, from about 20 nm to about 40 nm, from about 20 nm to about 35 nm, or from about 20 nm to about 30 nm, from about 13 nm to about 17 nm, from about 18 nm to about 20 nm, from about 22 nm to about 26 nm, from about 30 nm to about 50 nm, or from about 30 nm to about 45 nm, and a distribution of diameters of the nanowires can be uniform or highly uniform with a standard deviation in the range of about 1 nm to about 40 nm, such as from about 1 nm to about 30 nm, from about 1 nm to about 25 nm, from about 1 nm to about 20 nm, from about 1 nm to about 15 nm, from about 1 nm to about 10 nm, from about 1 nm to about 5 nm, from about 2 nm to about 25 nm, from about 2 nm to about 20 nm, from about 2 nm to about 15 nm, from about 2 nm to about 10 nm, from about 2 nm to about 5 nm, from about 3 nm to about 20 nm, from about 3 nm to about 15 nm, from about 3 nm to about 10 nm, from about 3 nm to about 5 nm, from about 4 nm to about 15 nm, from about 4 nm to about 10 nm, from about 4 nm to about 5 nm, from about 5 nm to about 15 nm, or from about 5 nm to about 10 nm, or, when expressed as a percentage of the average diameter, the standard deviation can be in the range of about 1% to about 99%, such as from about 1% to about 95%, from about 1% to about 90%, from about 1% to about 80%, from about 1% to about 70%, from about 1% to about 60%, from about 1% to about 50%, from about 1% to about 40%, from about 1% to about 30%, from about 1% to about 25%, from about 1% to about 20%, from about 5% to about 95%, from about 5% to about 90%, from about 5% to about 80%, from about 5% to about 70%, from about 5% to about 60%, from about 5% to about 50%, from about 5% to about 40%, from about 5% to about 30%, from about 5% to about 25%, from about 5% to about 20%, from about 10% to about 95%, from about 10% to about 90%, from about 10% to about 80%, from about 10% to about 70%, from about 10% to about 60%, from about 10% to about 50%, from about 10% to about 40%, from about 10% to about 30%, from about 10% to about 25%, from about 10% to about 20%, from about 15% to about 95%, from about 15% to about 90%, from about 15% to about 80%, from about 15% to about 70%, from about 15% to about 60%, from about 15% to about 50%, from about 15% to about 40%, from about 15% to about 30%, from about 15% to about 25%, or from about 15% to about 20%. As used herein, an average diameter and a distribution of diameters of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, among nanowires in the unpurified or purified product, an average diameter of the nanowires can be no greater than about 100 nm, no greater than about 60 nm, no greater than about 50 nm, no greater than about 40 nm, no greater than about 35 nm, no greater than about 33 nm, no greater than about 30 nm, no greater than about 27 nm, no greater than about 25 nm, no greater than about 23 nm, no greater than about 20 nm, no greater than about 17 nm, no greater than about 15 nm, no greater than about 13 nm, or no greater than about 10 nm, and down to about 5 nm, down to about 3 nm, or less, and a distribution of diameters of the nanowires can be uniform or highly uniform with a standard deviation in the range of about 1 nm to about 40 nm, such as from about 1 nm to about 30 nm, from about 1 nm to about 25 nm, from about 1 nm to about 20 nm, from about 1 nm to about 15 nm, from about 1 nm to about 10 nm, from about 1 nm to about 5 nm, from about 2 nm to about 25 nm, from about 2 nm to about 20 nm, from about 2 nm to about 15 nm, from about 2 nm to about 10 nm, from about 2 nm to about 5 nm, from about 3 nm to about 20 nm, from about 3 nm to about 15 nm, from about 3 nm to about 10 nm, from about 3 nm to about 5 nm, from about 4 nm to about 15 nm, from about 4 nm to about 10 nm, from about 4 nm to about 5 nm, from about 5 nm to about 15 nm, or from about 5 nm to about 10 nm, or, when expressed as a percentage of the average diameter, the standard deviation can be in the range of about 1% to about 99%, such as from about 1% to about 95%, from about 1% to about 90%, from about 1% to about 80%, from about 1% to about 70%, from about 1% to about 60%, from about 1% to about 50%, from about 1% to about 40%, from about 1% to about 30%, from about 1% to about 25%, from about 1% to about 20%, from about 5% to about 95%, from about 5% to about 90%, from about 5% to about 80%, from about 5% to about 70%, from about 5% to about 60%, from about 5% to about 50%, from about 5% to about 40%, from about 5% to about 30%, from about 5% to about 25%, from about 5% to about 20%, from about 10% to about 95%, from about 10% to about 90%, from about 10% to about 80%, from about 10% to about 70%, from about 10% to about 60%, from about 10% to about 50%, from about 10% to about 40%, from about 10% to about 30%, from about 10% to about 25%, from about 10% to about 20%, from about 15% to about 95%, from about 15% to about 90%, from about 15% to about 80%, from about 15% to about 70%, from about 15% to about 60%, from about 15% to about 50%, from about 15% to about 40%, from about 15% to about 30%, from about 15% to about 25%, or from about 15% to about 20%. As used herein, an average diameter and a distribution of diameters of nanowires in an unpurified or a purified product can be based on manual or automated inspection of one or more imaged samples, and can be calculated relative to a sample size of nanowires in the imaged samples of at least 50, at least 100, at least 500, or at least 1,000.

As another example, another characterization of the unpurified or purified product is an amount of a templating agent (e.g., PVP) in the product, where the amount of the templating agent can correspond to, or can include, an amount of the templating agent that is bound to nanowires (as well as any other nanostructures and microstructures) in the product. In some implementations, nanowires and other solids or particulate material, along with a surface-bound templating agent, can be separated from other components using gravity sedimentation, centrifugation, or other similar technique. In the case of a higher molecular weight templating agent, the use of centrifugation along with a suitable solvent or a combination of solvents, such as acetone and water, can facilitate settling of the solids or particulate material. The resulting settled solids, such as in the form of a pellet, can be subjected to Thermogravimetric Analysis (or TGA) to determine an amount of the surface-bound templating agent.

An example TGA procedure for the case of silver nanowires is shown in FIG. 20 and explained as follows. Specifically, a weight of the pellet is monitored as a temperature is raised. Upon reaching a temperature T_{A} (e.g., about 200° C. in this example), the surface-bound templating agent in the pellet, having a weight m_{A}, begins to decompose. Decomposition of the surface-bound templating agent can occur by carbonization that yields gases, and is evidenced by a first step-like drop in the weight of the pellet. Upon reaching a temperature T_{B} (e.g., about 400° C. in this example) in a plateau region after the first step-like drop, the surface-bound templating agent in the pellet, having a weight m_{B}, has substantially fully decomposed. A remaining material in the pellet at this point is primarily in the form of silver nanowires and silver nanoparticles, along with a halide-containing material as either, or both, AgCl and AgBr, which can be in the form of nanoparticles or microparticles that are formed in-situ from one or more added SPAs. The temperature T_{B} also corresponds to a beginning of decomposition of either, or both, AgCl and AgBr, which is evidenced by a second step-like drop in the weight of the pellet. Upon reaching a temperature T_{C} (e.g., about 800° C. in this example) in a plateau region after the second step-like drop, the halide as either, or both, Cl and Br in the pellet, having a weight m_{C}, has substantially fully decomposed. According to this example TGA procedure, a weight percentage of the surface-bound templating agent, relative to a total weight of all solids or particulate material, is calculated as wt. % templating agent=(m_{A}−m_{B})/m_{A}×100%, a weight percentage of the halide, relative to a total weight of all solids or particulate material, is calculated as wt. % chloride=0.247×(m_{B}−m_{C})/m_{A}×100% (or wt. % bromide=0.426×(m_{B}−m_{C})/m_{A}×100%), and a weight percentage of silver, relative to a total weight of all solids or particulate material, is calculated as wt. % silver=(100−wt. % templating agent−wt. % halide). FIG. 20 shows a typical TGA plot for the case of NaCl as a SPA, and a profile of the second step-like drop in the TGA plot can be different depending upon a particular halide used as a SPA, such as KBr.

In some implementations, a weight percentage of a surface-bound templating agent, relative to a total weight of all solids or particulate material, can be in the range of about 0.05% to about 40%, such as from about 0.05% to about 35%, from about 0.05% to about 30%, from about 0.05% to about 25%, from about 0.05% to about 20%, from about 0.05% to about 15%, from about 0.05% to about 10%, from about 0.05% to about 5%, from about 0.05% to about 4%, from about 0.05% to about 3%, from about 0.05% to about 2%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 5%, from about 0.1% to about 4%, from about 0.1% to about 3%, from about 0.1% to about 2%, from about 1% to about 35%, from about 1% to about 30%, from about 1% to about 25%, from about 1% to about 20%, from about 1% to about 15%, from about 1% to about 10%, from about 1% to about 5%, from about 1% to about 4%, from about 1% to about 3%, from about 1% to about 2%, from about 5% to about 35%, from about 5% to about 30%, from about 5% to about 25%, from about 5% to about 20%, from about 5% to about 15%, from about 5% to about 10%, from about 10% to about 35%, from about 10% to about 30%, from about 10% to about 25%, from about 10% to about 20%, from about 10% to about 15%, from about 15% to about 35%, from about 15% to about 30%, from about 15% to about 25%, from about 15% to about 20%, from about 20% to about 35%, from about 20% to about 30%, from about 20% to about 25%, from about 25% to about 35%, or from about 25% to about 30%. In some implementations, a weight percentage of a surface-bound templating agent can depend on a diameter (e.g., an average diameter) of nanowires, with a higher weight percentage of the surface-bound templating agent for smaller diameter nanowires, and a lower weight percentage of the surface-bound templating agent for larger diameter nanowires.

In some implementations, a weight percentage of a halide, relative to a total weight of all solids or particulate material, can be in the range of about 0.05% to about 20%, such as from about 0.05% to about 15%, from about 0.05% to about 10%, from about 0.05% to about 5%, from about 0.05% to about 4%, from about 0.05% to about 3%, from about 0.05% to about 2%, from about 0.1% to about 20%, from about 0.1% to about 15%, from about 0.1% to about 10%, from about 0.1% to about 5%, from about 0.1% to about 4%, from about 0.1% to about 3%, from about 0.1% to about 2%, from about 1% to about 20%, from about 1% to about 15%, from about 1% to about 10%, from about 1% to about 5%, from about 1% to about 4%, from about 1% to about 3%, from about 1% to about 2%, from about 5% to about 20%, from about 5% to about 15%, from about 5% to about 10%, about 10% to about 20%, from about 10% to about 15%, or from about 15% to about 20%. In some implementations, the halide includes bromine and is substantially devoid of chlorine, such that a weight percentage of chlorine, relative to a total weight of all solids or particulate material, can be in the range of less than about 0.05%, such as no greater than about 0.01%, no greater than about 0.005%, no greater than about 0.001%, no greater than about 0.0005%, or no greater than about 0.0001%.

As a further example, among nanowires in the unpurified or purified product, at least about 30% of the nanowires (e.g., by number) can be single crystalline, such as at least about 40%, at least about 50%, at least about 60%, at least about 70%, at least about 80%, at least about 90%, at least about 95%, or at least about 98%, and up to about 99%, up to about 99.9%, or up to about 100%, relative to a sample size of the nanowires of at least 50, at least 100, at least 500, or at least 1,000.

In terms of batch-to-batch consistency across different batches of the unpurified or purified product (using substantially identical manufacturing conditions), a value corresponding to an average aspect ratio of nanowires in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire product by blending or otherwise combining multiple batches of nanowires, each batch characterized by a value of an average aspect ratio of nanowires in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire product can be at least 2, such as at least 3, at least 4, at least 5, at least 10, at least 15, or at least 20.

Also, in terms of batch-to-batch consistency across different batches of the unpurified or purified product (using substantially identical manufacturing conditions), a value corresponding to an average size of nanowire-forming seeds in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire-forming seed product by blending or otherwise combining multiple batches of nanowire-forming seeds, each batch characterized by a value of an average size of nanowire-forming seeds in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire-forming seed product can be at least 2, such as at least 3, at least 4, at least 5, at least 10, at least 15, or at least 20.

Also, in terms of batch-to-batch consistency across different batches of the unpurified or purified product (using substantially identical manufacturing conditions), a value corresponding to an average length of nanowires in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire product by blending or otherwise combining multiple batches of nanowires, each batch characterized by a value of an average length of nanowires in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire product can be at least 2, such as at least 3, at least 4, at least 5, at least 10, at least 15, or at least 20.

Also, in terms of batch-to-batch consistency across different batches of the unpurified or purified product (using substantially identical manufacturing conditions), a value corresponding to a chemical purity of nanowire-forming seeds in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire-forming seed product by blending or otherwise combining multiple batches of nanowire-forming seeds, each batch characterized by a value of a chemical purity of nanowire-forming seeds in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire-forming seed product can be at least 2, such as at least 3, at least 4, at least 5, at least 10, at least 15, or at least 20.

Also, in terms of batch-to-batch consistency across different batches of the unpurified or purified product (using substantially identical manufacturing conditions), a value corresponding to an average diameter of nanowires in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire product by blending or otherwise combining multiple batches of nanowires, each batch characterized by a value of an average diameter of nanowires in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire product can be at least 2, such as at least 3, at least 4, at least 5, at least 10, at least 15, or at least 20.

Also, in terms of batch-to-batch consistency across different batches of the unpurified or purified product (using substantially identical manufacturing conditions), a value corresponding to a weight percentage of a surface-bound templating agent or a halide in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire product by blending or otherwise combining multiple batches of nanowires, each batch characterized by a value of the weight percentage of the surface-bound templating agent or the halide in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire product can be at least 2, such as at least 3, at least 4, at least 5, at least 10, at least 15, or at least 20.

And, in terms of batch-to-batch consistency across different batches of the unpurified or purified product (using substantially identical manufacturing conditions), a value corresponding to a metal content or a concentration of nanowire-forming seeds (having a characteristic shape) in each batch can be obtained, and a coefficient of variation (e.g., a standard deviation divided by an average or a mean across the batches) in values across the batches can be no greater than about 30%, such as no greater than about 25%, no greater than about 20%, no greater than about 15%, no greater than about 10%, or no greater than about 5%, and down to about 2%, down to about 1%, or less. The number of batches used for determining batch-to-batch consistency can be at least 2, such as at least 3, at least 4, at least 5, at least 10, at least 15, or at least 20. This batch-to-batch consistency allows the production of a nanowire-forming seed product by blending or otherwise combining multiple batches of nanowire-forming seeds, each batch characterized by a value of a metal content or a concentration of nanowire-forming seeds in the batch, and a coefficient of variation in the values across the batches can be no greater than about 30%, such as no greater than about 25%, no greater than about 20%, no greater than about 15%, no greater than about 10%, or no greater than about 5%, and down to about 2%, down to about 1%, or less. The number of batches combined in the nanowire-forming seed product can be at least 2, such as at least 3, at least 4, at least 5, at least 10, at least 15, or at least 20.

As a further example, nanowires having desired morphologies can be embedded or otherwise incorporated in a variety of substrates or other host materials to form transparent conductors (or transparent conductive electrodes) having a desired combination of two or more of the following performance characteristics, namely 1) a haze no greater than about 2.5%, no greater than about 2%, no greater than about 1.9%, no greater than about 1.8%, no greater than about 1.7%, no greater than about 1.6%, no greater than about 1.5%, no greater than about 1.4%, no greater than about 1.3%, no greater than about 1.2%, no greater than about 1.1%, no greater than about 1%, no greater than about 0.9%, no greater than about 0.8%, no greater than about 0.7%, no greater than about 0.6%, or no greater than about 0.5%, and down to about 0.4%, down to about 0.2%, or less; 2) a light transmittance (e.g., in the visible range of about 400 nm to about 700 nm) of at least about 85%, at least about 87%, at least about 90%, at least about 93%, or at least about 95%, and up to about 97%, up to about 98%, or more; and 3) a sheet resistance no greater than about 500 Ω/sq, no greater than about 400 Ω/sq, no greater than about 300 Ω/sq, no greater than about 200 Ω/sq, no greater than about 150 Ω/sq, no greater than about 100 Ω/sq, no greater than about 75 Ω/sq, or no greater than about 50 Ω/sq, and down to about 30 Ω/sq, down to about 20 Ω/sq, or less. Embedding of nanowires can be carried out as explained in, for example, U.S. Patent Application Publication No. 2011/0281070, entitled “STRUCTURES WITH SURFACE-EMBEDDED ADDITIVES AND RELATED MANUFACTURING METHODS” and published on Nov. 17, 2011, the disclosure of which is incorporated herein by reference in its entirety.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

### Production and Characterization of Silver Nanowires

Glycerol Reaction (Higher Power, Single-Staged):

In this example, a single-staged reaction was carried out according to the implementation of FIG. 2A. First, a stock solution “A” was prepared by dissolving about 92.63 g of PVP (MW: about 55,000) in about 3974.82 g of glycerol at about 60° C. in a 4 L beaker using a heating mantle. Once PVP is substantially fully dissolved, a transparent solution was cooled down to room temperature. A stock solution “B” of a SPA was prepared by dissolving about 1.19 g of sodium chloride (or NaCl) in about 10 g of de-ionized water, followed by an addition of about 252.25 g of glycerol. The resultant mixture was then well shaken to form a substantially homogeneous solution.

Next, about 125 g of stock solution “A” and about 5.25 mL of stock solution “B” were mixed together in a 250 mL beaker and heated in a microwave oven (about 700 W, about 2.45 GHz) for about 1 min using power level 5 (about 350 W). Then about 2 g of AgNO₃ granular powder was added to this solution, followed by vigorous shaking for about 5 min until AgNO₃ is substantially fully dissolved. The resulting reaction mixture was then heated for about 10 min at the same power level. A volume of the reaction mixture was about 0.1 L, and a reaction temperature was periodically recorded with a thermocouple throughout the reaction. After microwave irradiation, the hot reaction mixture was cooled down to room temperature or poured into about 100 mL isopropanol or methanol, which was pre-cooled in an ice-water bath.

For structural characterization of resulting silver nanowires, about 2 mL aliquot of the crude reaction mixture was mixed with about 5 mL of methanol (or methanol/acetone (3:1 v/v) or water/acetone (1:1 v/v)) and centrifuged at about 1500 rpm for about 5 min. A supernatant was carefully decanted and washed several times with methanol to reduce unwanted glycerol and PVP. The purified silver nanowires were re-dispersed in methanol by gentle wrist-action shaking and imaged by optical microscope (or OM) and transmission electron microscope (or TEM).

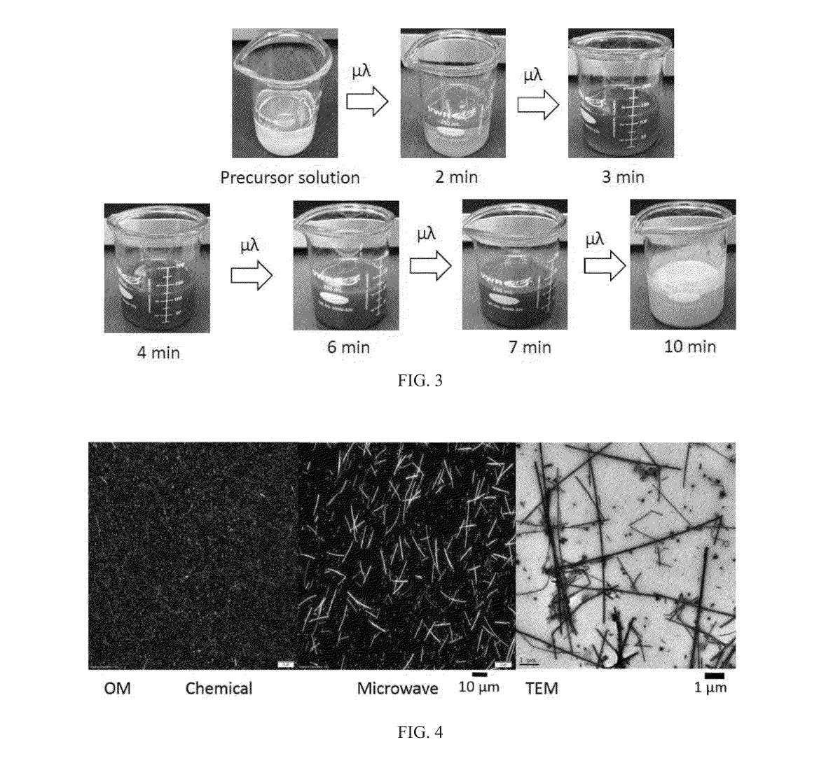

During the reaction, a color of the reaction mixture progressively changed from almost colorless to translucent yellow, translucent light orange, translucent dark brown, opaque brown orange, opaque red, opaque dark purple, opaque dark purple gray, and finally opaque light gray olive, as depicted in FIG. 3. A rapid transition was observed after about 7 min, when the reaction mixture quickly changed from opaque dark purple to opaque gray in less than about 1 minute at about 160° C. It is believed that this temperature is a transition temperature from a seeding phase to a growth phase. During the seeding phase, silver nanoparticle seeds are formed at lower temperatures, and different colors can be correlated to different sizes of the seeds. Above about 150° C., glycerol quickly reduces a remainder of a silver precursor to initiate growth of silver nanowires. When the reaction reached about 180° C., bubbling became evident, which can be attributed to a reduction of nitrate species from the silver precursor that released gas.

A typical reaction produces relatively short and relatively thick silver nanowires with a relatively wide diameter distribution from about 20-60 nm and about 2-10 μm in lengths (average aspect ratio of about 100). The as-synthesized sample often contains nanoparticles as a by-product; however, microwave-assisted synthesis resulted in a higher nanowire to nanoparticle ratio when compared with other wet chemical methods. FIG. 4 shows typical OM and TEM images of resulting silver nanowires. In as short as about 10 min, silver nanowires with an average diameter less than about 50 nm were obtained at 3500 W/L, compared to an alternative wet chemical method producing 70 nm or greater diameter silver nanowires in a longer time of 30 min. Also, the method of this example produced silver nanowires using reduced volumetric microwave power density, compared to an alternative method using substantially higher microwave power density in the range of 8,000-10,000 W/L.

### Example 2

### Production and Characterization of Silver Nanowires

Glycerol Reaction (Lower Power, Single-Staged):

A reaction mixture was prepared using the same procedure as explained in Example 1. Next, the mixture was reacted at power level 5 (about 350 W) for about 2 min, then at power level 3 (about 210 W) for about 5.5 min, and finally at power level 2 (about 140 W) for about 24.5 min.

At a lower power level, a reaction rate is slower, thereby increasing a reaction time to about 33 min. After about 15 min of reaction at about 140 W, a color of the reaction mixture changed to opaque dark purple instead of about 6 min at power lever 5 as observed in Example 1. The whole color transition from opaque dark purple to opaque gray occurred over about 15 min, and a final crude reaction mixture (at about 140-145° C.) was darker than a typical reaction as observed in Example 1.

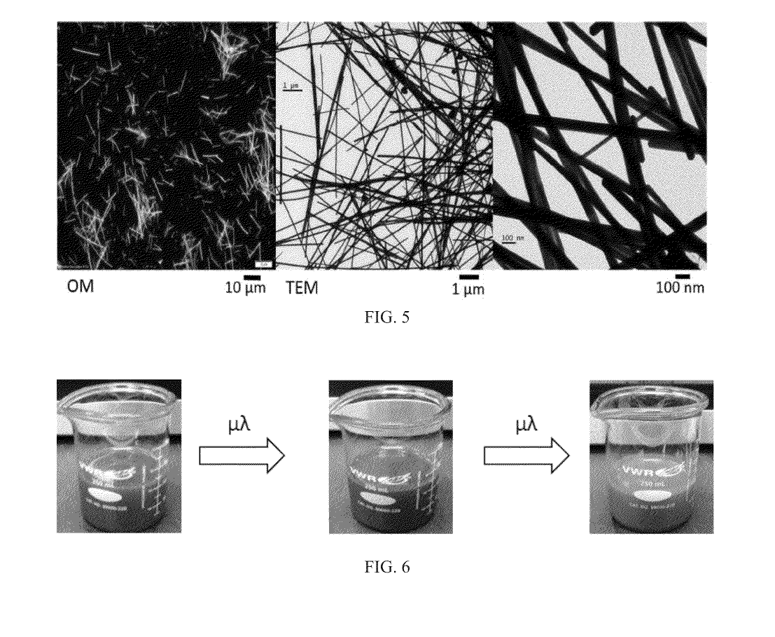

The reaction led to relatively thin and longer nanowires with a relatively uniform diameter distribution around about 50 nm and about 10-15 nm in lengths with a lower impurity content, in contrast to an alternative microwave-assisted method producing thicker nanowires with diameters greater than 120 nm. FIG. 5 shows typical OM and TEM images of resulting silver nanowires.

### Example 3

### Production and Characterization of Silver Nanowires

Glycerol Reaction (Two-Staged with Pre-Seeding):

In this example, a two-staged reaction was carried out according to the implementation of FIG. 2G. During a first stage of a reaction, about 35 g of AgNO₃ was dissolved in about 2.57 kg of glycerol preheated to about 60° C., followed by an addition of about 58.7 g of PVP in a powder form (MW: about 55,000) under constant stirring at about 500 rpm. In the meantime, a stock solution “A” was prepared by dissolving about 1.19 g of NaCl in about 10 g of de-ionized water, followed by an addition of about 252.25 g of glycerol. Then, about 105 mL of stock solution “A” was injected into the AgNO₃/PVP mixture, and the resulting reaction mixture was heated via non-radiative heating to about 80° C. After about 16 hr of the reaction, a reaction temperature was raised to about 95° C. for about 6 hr. A color of the reaction mixture turned opaque dark purplish brown (see FIG. 6) within the next about 4 hr, indicating the formation of silver nanoparticle seeds.

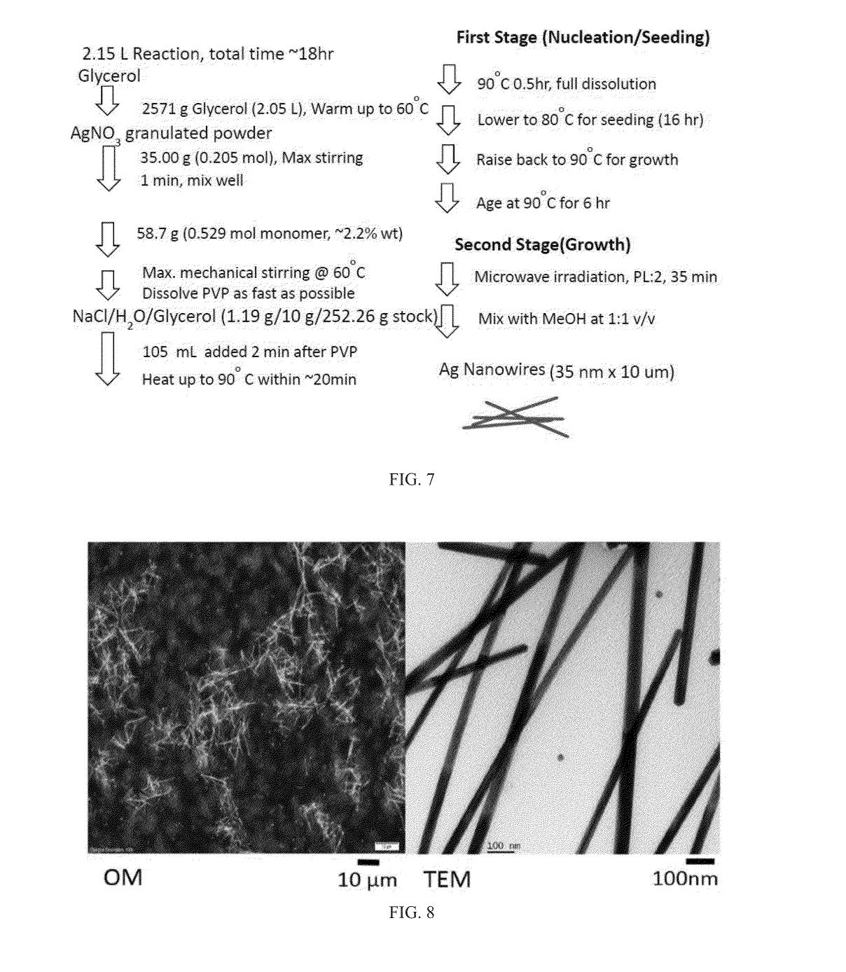

For a second stage, about 100 mL of the reaction mixture was transferred to a 250 mL beaker and microwave irradiated at about 140 W for about 35 min. A final transition temperature was lower (about 145° C.) compared to Example 1. A progression of color changes of the reaction mixture during microwave irradiation is shown in FIG. 6, and a flow chart of the two-staged reaction is explained in detail in FIG. 7.

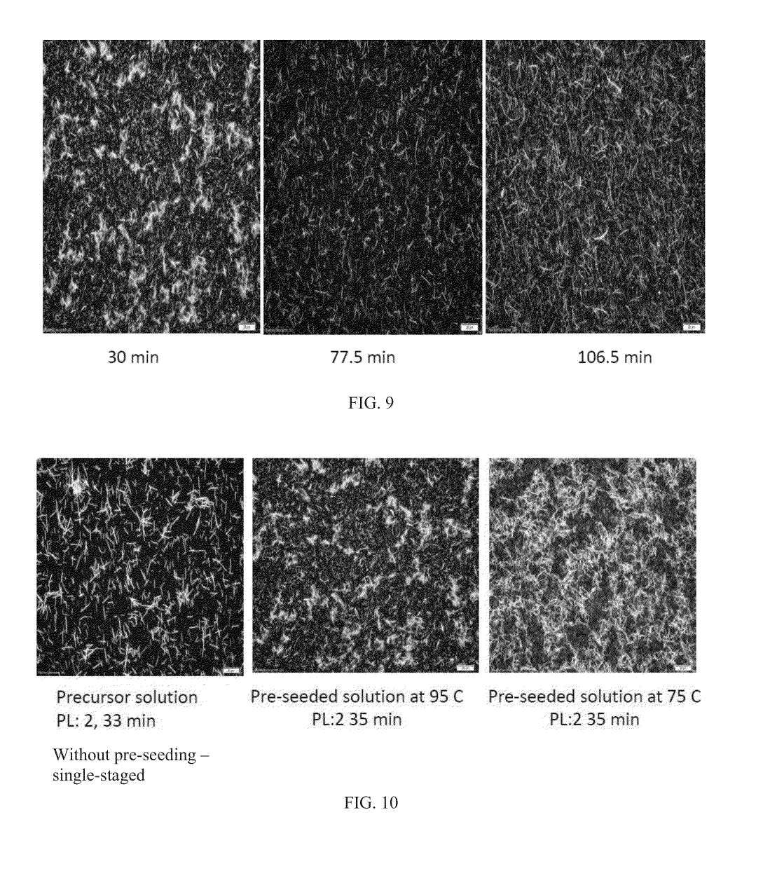

It is noticed that use of a pre-seeded reaction mixture promoted the growth of thinner nanowires with about 30-45 nm in diameters and lengths of about 5-10 μm (aspect ratio of about 300-400). FIG. 8 shows typical OM and TEM images of resulting silver nanowires. Increasing a duration of the second stage at a lower growth temperature formed long and thin silver nanowires (see FIG. 9). Moreover, a nanowire diameter can be further reduced by lowering a seeding temperature (see FIG. 10).

### Example 4

### Production and Characterization of Silver Nanowires

Glycerol Reaction (Two-Staged with Pre-Seeding, Longer Duration):

The same procedure for the first and second stages was carried out as explained in Example 3. Next, the reaction mixture was cooled down to room temperature, and, after cooling down, the reaction mixture was reheated at about 350 W for about 1 min, followed by about 10 min cycle at about 140 W in a microwave oven.

No noticeable color difference was observed after about 11 min, indicating a similar diameter distribution, whereas a final reaction temperature was slightly lower (about 120° C.) compared to Example 3.

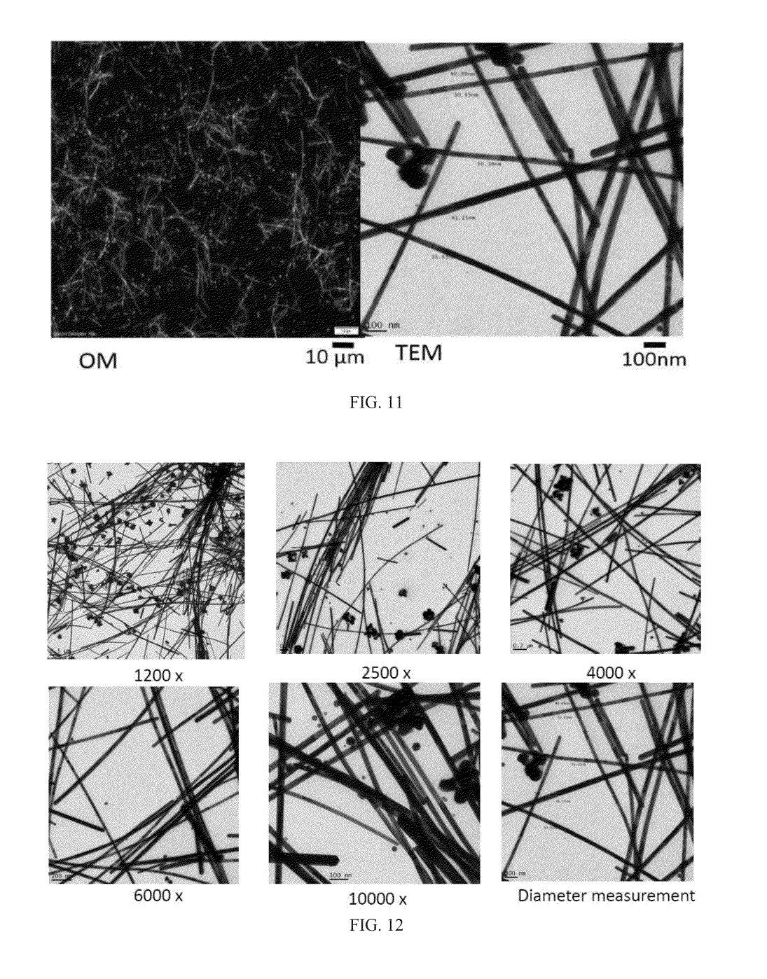

A longer growth duration at a lower power level promoted the growth of longer nanowires than a typical reaction, without noticeably affecting a diameter distribution as shown in FIG. 11. The reaction yielded thin silver nanowires with about 30-45 nm in diameters and about 10-20 μm in lengths (aspect ratio of about 500-1000) (see FIG. 12). Importantly, and even accounting for a seeding duration, a total reaction time (including a growth duration of about 95 min) is still significantly shorter in contrast to a typical 24 hr reaction time for alternative polyol-based synthesis methods to produce silver nanowires with high aspect ratio.

### Example 5

### Production and Characterization of Silver Nanowires

Glycerol Reaction (Multi-Staged with Pre-Seeding and Reactant Addition):

In this example, a multi-staged reaction was carried out according to the implementation of FIG. 2H. First, during a first stage, a stock solution “B” of a SPA was prepared by dissolving about 1.19 g of NaCl in about 10 g of de-ionized water, followed by an addition of about 252.25 g of glycerol. A proportion of about 35 g of AgNO₃ was dissolved in about 2.57 kg of glycerol preheated to about 60° C., and then about 58.7 g of PVP in a powder form (MW: about 55,000) was added to this mixture under constant stirring at about 500 rpm. Further, about 110 mL of stock solution “B” was injected into this substantially homogenous mixture, and the resulting reaction mixture was then heated via non-radiative heating to about 75° C. for about 24 hr.

In a second stage, about 100 mL of the reaction mixture was transferred to a 250 mL beaker and reacted in a microwave oven for a few hours at about 75-85° C. to promote the growth of thin nanowires. Extended microwave irradiation at higher power levels may cause fusing and partial melting of nanowires due to dielectric superheating. To mitigate against overheating and subsequent increase in nanowire diameter with time, microwave-assisted heating was interrupted periodically for a few minutes, and about 5 mL of about 0.53 M PVP in glycerol solution was added twice to the reaction mixture after every about 130 min. AgNO₃ also can be added to the reaction mixture during the second stage.

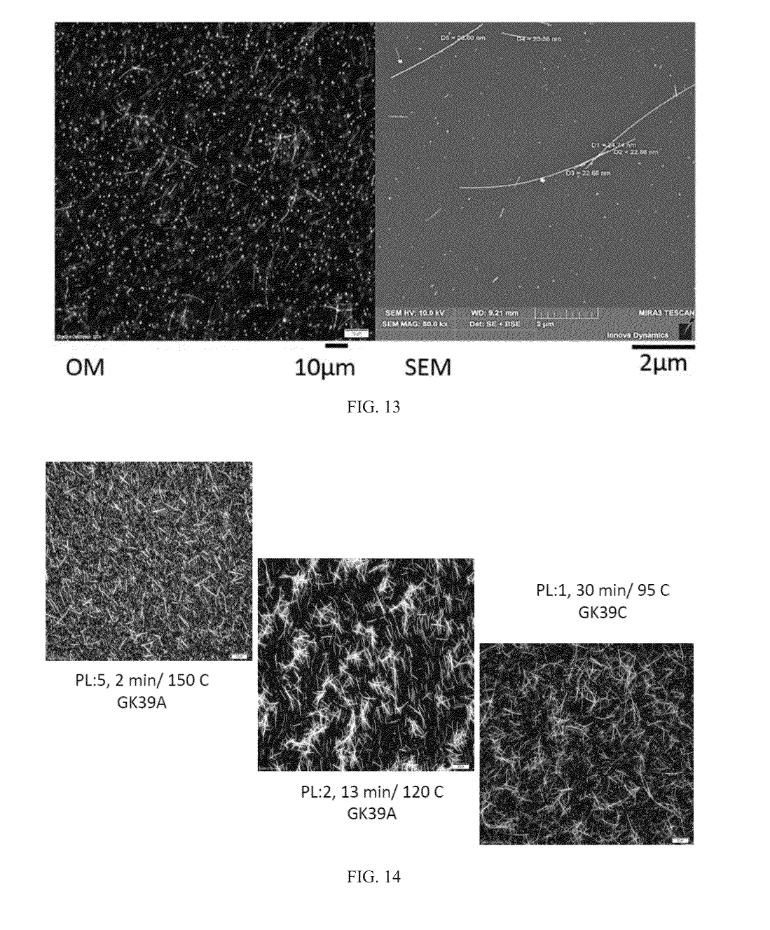

A lower seeding temperature and a lower growth temperature promoted uniform growth of thin nanowires with about 22-26 nm in diameters and lengths of about 5-8 μm. FIG. 13 shows typical OM and scanning electron microscope (or SEM) images of resulting silver nanowires. In this example, very thin silver nanowires with less than about 25 nm in diameters were formed during a growth duration of about 3-4 hours, compared to 72-96 hours with alternative wet chemical methods using a heating mantle. Notably, a resulting population of silver nanowires of uniform diameter and length distributions allows precise dimensional control desirable for low-haze transparent conducting electrodes.

### Example 6

### Production and Characterization of Silver Nanowires

Glycerol Reaction (Two-Staged with Microwave-Assisted Seeding):

In this example, a multi-staged reaction was carried out according to the implementation of FIG. 2I. For a first stage, stock solutions “A” and “B” were prepared in a similar manner as explained in Example 1. About 125 g of stock solution “A” was heated in a microwave oven for about 1 min at about 350 W. Next, about 2 g of AgNO₃ granular powder was added to this solution and stirred for about 5 min until AgNO₃ is substantially fully dissolved, followed by an additional 5 min heating at the same power level. Then about 5.25 mL of stock solution “B” of a SPA was added to the mixture, and a resulting reaction mixture was reacted at about 140 W for 5 min. A volume of the reaction mixture was about 0.1 L. A light brown orange mixture was obtained after about 30 min exposure at power level 1 (about 70 W) and at about 78° C., confirming silver seed formation.

In a second stage of the reaction, the hot reaction mixture was transferred to a 3 neck round bottom flask and further heated to about 95° C. using a heating mantle. A total reaction time was about 24 hr, and a final crude reaction mixture was more reddish gray in color as opposed to typical gray olive product obtained with alternative methods.

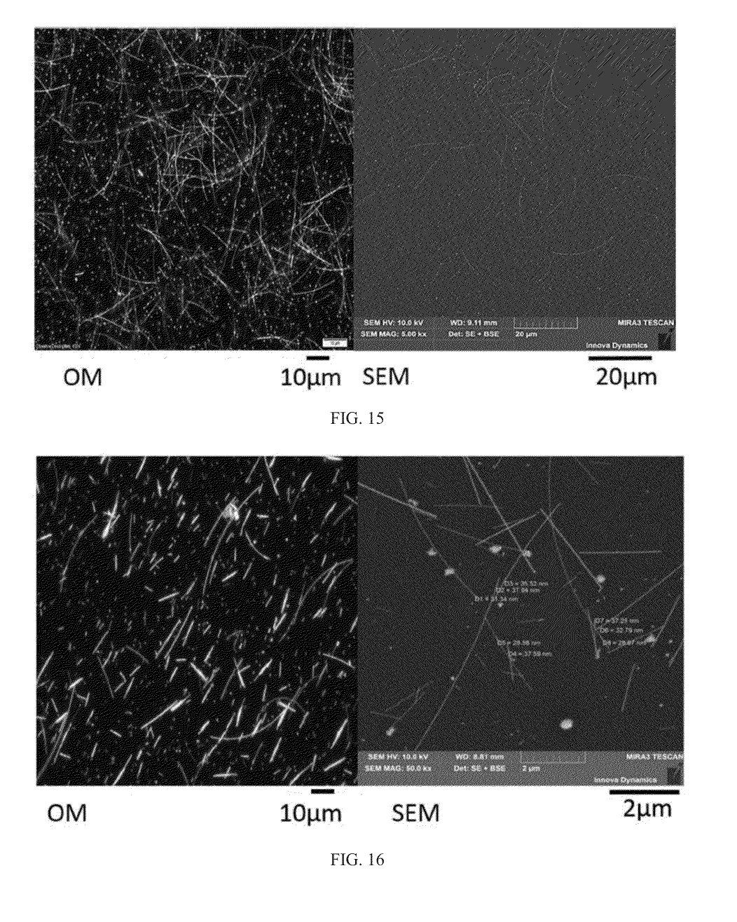

Microwave-assisted seeding reduced the total reaction time in about half, compared to alternative chemical seeding, and also yielded improvements in yield and length of resulting silver nanowires with a slight increase in diameter. Using optimized power level during a seeding phase, nanowire diameter can be reduced, and then combining microwave-assisted seeding with chemical synthesis forms long and thin nanowires with noticeably higher yield (see FIG. 14). Silver nanowires formed with microwave-assisted seeding were about 30-50 nm in diameters and about 15-30 μm in lengths, as shown in FIG. 15. In some implementations, a reaction mixture can include a solvent or a solvent mixture that includes water.

### Example 7

### Production and Characterization of Silver Nanowires

Glycerol Reaction (Single-Staged with about 25% Water):

Stock solutions “A” and “B” were prepared in a similar manner as described in Example 1. About 92 g of stock solution “A” mixed with about 25 g of de-ionized water was heated in a microwave oven for about 1 min at about 350 W. Next, about 2 g of AgNO₃ granular powder was added to this solution and stirred for about 5 min until AgNO₃ is substantially fully dissolved, followed by an additional about 1 min of heating at the same power level. Then, about 5.25 ml of stock solution “B” of a SPA was added, and a resulting reaction mixture was reacted at about 140 W for about 3 min. The reaction mixture was more brownish in color compared to Example 6. Further, the reaction mixture was heated at about 210 W for about 3 min, followed by about 7 min at about 140 W. A growth duration was about 10 min, while maintaining a growth temperature below the boiling point of water.

The growth of silver nanowires in the presence of water demonstrates the versatility of the microwave-assisted synthesis method with higher eco-efficiency. Lower PVP content resulted in longer nanowires with a similar diameter distribution compared to Example 6, as shown in FIG. 16. By further optimizing the PVP and SPA contents, nanowires with even higher aspect ratios above about 1,300 can be obtained.

### Example 8

### Production and Characterization of Silver Nanowires

Glycerol Reaction (Single-Staged with NaCl and KBr, and with Positive Pressure):

A stock solution “B” of SPA's was prepared by dissolving about 0.007 g of NaCl and about 0.0015 g of KBr in about 25 g of glycerol. First, about 40 g of glycerol was heated in a sealed reactor at about 210 W for about 1 min, followed by an addition of about 0.275 g of PVP (MW: about 1,300K) and further heating for about 3 min at about 310 W and about 1 min at about 70 W. A proportion of about 0.2 g of AgNO₃ was then added to the mixture, followed by vigorous shaking for about 5 min until AgNO₃ is substantially fully dissolved. After about 1 minute heating at the same power level, stock solution “B” was added, and a resulting reaction mixture was reacted for about 2 more min at about 70 W, followed by about 20 min at about 140 W, about 7 min at about 210 W, and about 5 min at about 70 W in the sealed reactor. A volume of the reaction mixture was about 50 mL.

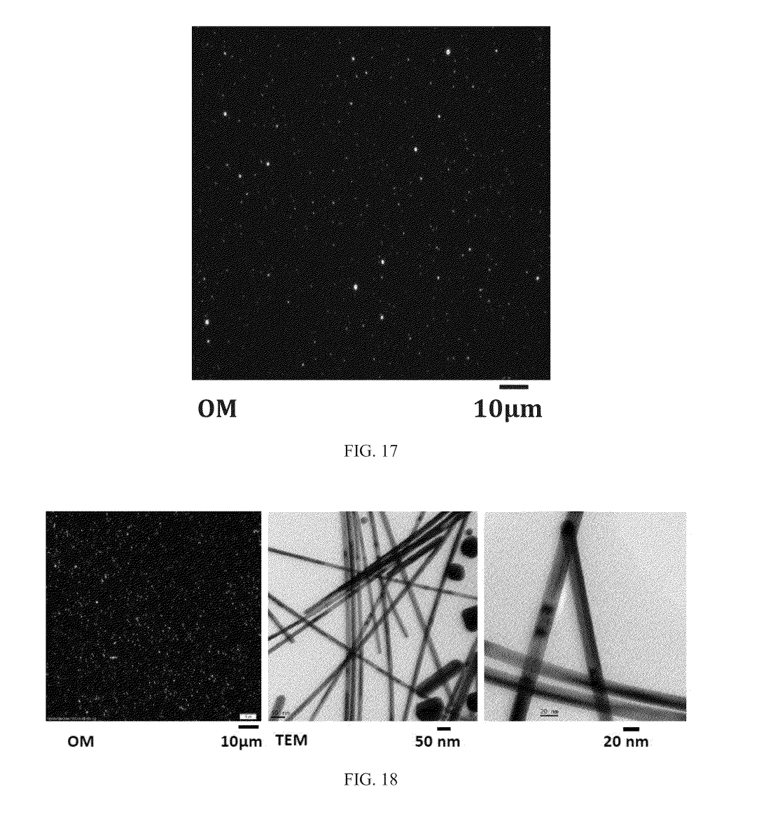

The moderately elevated pressure (above atmospheric pressure) within the sealed reactor, microwave irradiation, high molecular weight PVP, and NaCl with KBr promoted the formation of small diameter (about 18-20 nm) and long nanowires (about 10-20 μm) in less than about 60 min. Without positive pressure, a nanowire percentage (by number) in a crude reaction mixture dropped by about 30%, and a nanowire length dropped by about 27%, relative to corresponding values in the presence of positive pressure. Moreover, the use of a lower molecular weight PVP (MW: 55K or 360K) resulted in almost no detectable nanowires as shown in FIG. 17, indicating the desirability of higher molecular weight PVP during nanowire synthesis under positive pressure.

### Example 9

### Production and Characterization of Silver Nanowires

Glycerol Reaction (Single-Staged with KBr and Positive Pressure):

A stock solution “B” of SPA was prepared by dissolving about 0.09 g of KBr in about 75 g of glycerol. First, about 125 g of glycerol was heated in a sealed reactor at about 350 W for about 1 min, followed by an addition of about 1.65 g of PVP (MW: about 1,300K) and further heating for about 2 min at about 350 W and about 1 min at about 140 W. A proportion of about 1.2 g of AgNO₃ was then added to the mixture, followed by vigorous shaking for about 5 min until AgNO₃ is substantially fully dissolved. After about 2 min heating at the same power level, stock solution “B” was added, and a resulting reaction mixture was reacted for about 2 more min at about 140 W, followed by about 20 min at 210 W and about 30 min at about 70 W in the sealed reactor. A volume of the reaction mixture was about 160 mL.

KBr can be used to promote the growth of thinner silver nanowires, but, when used alone in alternative wet chemical methods, KBr often results in very low yields. Therefore, KBr is generally used in combination with AgCl or NaCl in alternative wet chemical methods. Surprisingly in this example, silver nanowires were formed in high yield in the presence of KBr alone with a further 25% reduction in diameter (about 13-17 nm) in comparison with use of both NaCl and KBr. In addition, the less intense microwave irradiation for a longer growth duration led to longer nanowires (up to about 30 μm). FIG. 18 shows typical OM and TEM images of resulting silver nanowires. The silver nanowires are so thin that it is difficult to detect the nanowires using an optical microscope.

### Example 10

### Production and Characterization of Silver Nanowires

Glycerol Reaction (Single-Staged with KBr and Excess Nitrate Anions, and with Positive Pressure):

A stock solution “B” of a first SPA was prepared by dissolving about 0.09 g of KBr in about 60 g of glycerol. A stock solution “C” of a second SPA was prepared by dissolving about 0.357 g of KNO₃ in about 1 g of de-ionized water and about 40 g of glycerol. About 100 g of glycerol was first heated in a sealed reactor at about 350 W for about 1 min, followed by an addition of about 1.65 g of PVP (MW: about 1,300K) and continued heating at about 350 W for about 2 min. Stock solution “B” was then added to this mixture and heated at about 140 W for about 2 min in the sealed reactor. After addition of about 0.9 g of AgNO₃, the solution was shaken vigorously for about 5 min until AgNO₃ is substantially fully dissolved and further heated for about 2 more min at the same power level. Next, stock solution “C” was added, and the resulting reaction mixture was reacted for about 2 more min at about 140 W, followed by about 20 min at about 210 W, and about 30 min at about 70 W in the sealed reactor. A volume of the reaction mixture was about 160 mL.

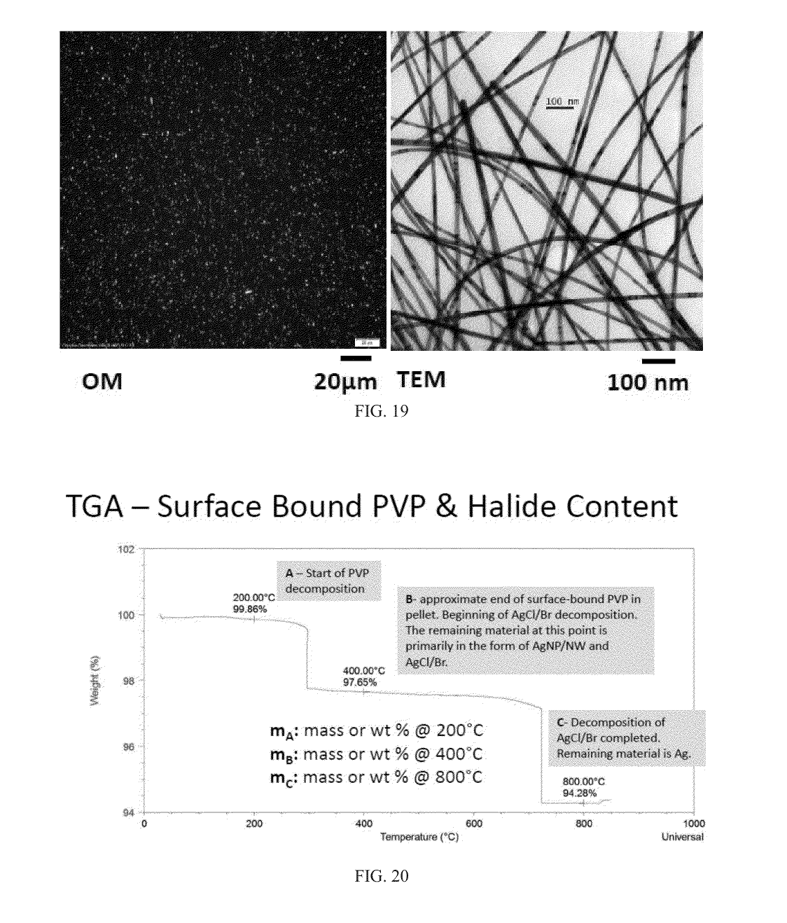

The addition of excess nitrate anions (from the second SPA) improved the nanowire length and yield in the crude reaction mixture. It is observed that KNO₃ is a more effective SPA compared to NaNO₃. Nanowires as long as about 50 μm and as thin as about 15 nm are produced using microwave irradiation under moderate positive pressure in less than about 70 min. FIG. 19 shows typical OM and TEM images of resulting high aspect ratio silver nanowires.

While this disclosure has been described with reference to the specific embodiments thereof, it should be understood by those skilled in the art that various changes may be made and equivalents may be substituted without departing from the true spirit and scope of this disclosure as defined by the appended claims. In addition, many modifications may be made to adapt a particular situation, material, composition of matter, method, or process to the objective, spirit and scope of this disclosure. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of this disclosure. Accordingly, unless specifically indicated herein, the order and grouping of the operations are not limitations of this disclosure.

What is claimed is:

1. A method of producing nanowires, comprising:
irradiating
(i) a metal-containing reagent;
(ii) a templating agent;
(iii) a reducing agent; and
(iv) a seed-promoting agent (SPA)
in a reaction medium and under a condition of an elevated pressure above atmospheric pressure to produce nanowires.

2. The method of claim 1, wherein the irradiating includes applying microwave radiation.

3. The method of claim 1, wherein the irradiating includes applying microwave radiation at a power density per unit volume of the reaction medium in a range of 100 W/L to 7,500 W/L.

4. The method of claim 1, wherein the irradiating includes applying microwave radiation at a sequence of different power levels, such that the reaction medium has a first temperature for at least a portion of a first duration, followed by a second temperature for at least a portion of a second duration, and the second temperature is different from the first temperature.

5. The method of claim 4, wherein the first temperature is in a range of 100° C. to 200° C., and the second temperature is in a range of 60° C. to 140° C.

6. The method of claim 1, wherein the elevated pressure is up to 50 psi.

7. The method of claim 1, wherein the reaction medium includes an alcohol including at least three hydroxyl groups per molecule.

8. The method of claim 7, wherein the alcohol is glycerol.

9. The method of claim 1, wherein the templating agent is poly(vinylpyrrolidone) having an average molecular weight greater than 55,000.

10. The method of claim 9, wherein the average molecular weight is at least 360,000.

11. The method of claim 1, wherein the irradiating includes forming the reducing agent as an oxidized derivative of the reaction medium.

12. The method of claim 1, wherein the SPA is a source of halide anions, and a ratio of a concentration of the halide anions in the reaction medium to an overall concentration of the metal in the reaction medium, including ionic and elemental metal forms, is in a range of 0.001 to 10.

13. The method of claim 1, wherein the SPA is a source of bromine anions, and the reaction medium is substantially devoid of chlorine anions.

14. The method of claim 1, wherein:
the SPA is a first SPA that is a source of bromine anions, and
the irradiating further includes irradiating a second SPA that is a source of nitrate anions different from silver nitrate.

15. The method of claim 14, wherein a ratio of a concentration of the nitrate anions in the reaction medium to an overall concentration of the metal in the reaction medium, including ionic and elemental metal forms, is in a range of 0.1 to 20.

16. The method of claim 1, wherein:
the reaction medium includes an alcohol including at least three hydroxyl groups per molecule,
the metal-containing reagent is silver nitrate or silver perchlorate,
the templating agent is poly(vinylpyrrolidone) having an average molecular weight of at least 1,300,000,
the reducing agent is an oxidized derivative of the alcohol,
the SPA is a first SPA that is potassium bromide,
the irradiating includes applying microwave radiation,
the elevated pressure is up to 50 psi, and
the irradiating further includes irradiating a second SPA that is potassium nitrate.

17. The method of claim 1, wherein at least one of the nanowires has a length of at least 10 μm and a diameter no greater than 20 nm.

18. A method of producing nanowires, comprising:
combining
(i) a solvent;
(ii) a metal-containing reagent;
(iii) a templating agent; and
(iv) a seed-promoting agent (SPA)
to produce a reaction mixture; and
energizing the reaction mixture under conditions of applying a first energizing mechanism, followed by applying a second energizing mechanism,
wherein one of the first energizing mechanism and the second energizing mechanism includes irradiation, and another one of the first energizing mechanism and the second energizing mechanism includes non-radiative heating.

19. The method of claim 18, wherein the first energizing mechanism includes microwave irradiation, and the second energizing mechanism includes non-radiative heating.

20. A nanowire composition, comprising:
a liquid and a particulate material,
at least 65% by number of the particulate material corresponds to nanowires,
an average length of the nanowires is at least 10 nm,
an average diameter of the nanowires is no greater than 20 nm.

21. The nanowire composition of claim 20, wherein at least 70% by number of the particulate material corresponds to the nanowires.

22. The nanowire composition of claim 20, wherein the average length of the nanowires is at least 13 μm.

23. The nanowire composition of claim 20, wherein a standard deviation of lengths of the nanowires, expressed as a percentage of the average length, is in a range of 5% to 95%.

24. The nanowire composition of claim 20, wherein the average diameter of the nanowires is no greater than 17 nm.

25. The nanowire composition of claim 20, wherein a standard deviation of diameters of the nanowires, expressed as a percentage of the average diameter, is in a range of 1% to 50%.

26. The nanowire composition of claim 20, further comprising a templating agent, and the nanowires are stabilized by the templating agent.

27. The nanowire composition of claim 26, wherein the templating agent is bound to the nanowires.

28. The nanowire composition of claim 26, wherein the templating agent is poly(vinylpyrrolidone).

29. The nanowire composition of claim 26, wherein a weight percentage of the templating agent, relative to a total weight of solids, is in a range of 0.05% to 40%.

30. The nanowire composition of claim 20, wherein the particulate material includes a halide, and a weight percentage of the halide, relative to a total weight of solids, is in a range of 0.05% to 20%.
